(19) United States
(12) Patent Application Publication
(10) Pub. No.: US 2007/0071319 A1
(43) Pub. Date: Mar. 29, 2007

(54) Method, apparatus, and program for dividing images

(75) Inventor: Toshimitsu Fukushima, Asaka-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/523,720

(22) Filed: Sep. 20, 2006

(30) Foreign Application Priority Data
Sep. 26, 2005 (JP) 277541/2005

(51) Int. Cl. G06K 9/34; G06K 9/46; G06K 15/00

(52) U.S. Cl. 382/173; 382/190; 358/1.18

(57) ABSTRACT

Segmentation of the faces and facial parts, such as eyes, mouths, and noses included in an image is avoided as much as possible, when the image is divided to perform divided printing, for example. Whether the size of each of a specified number of smaller regions is greater than the size of a main facial region is judged. In the case that the result of judgment is affirmative, a first division setting section sets a division region and division locations such that the boundaries of the smaller regions are at positions other than that of the main facial region. In the case that the result of judgment is negative, a second division setting section sets a division region and division locations such that the boundaries of the smaller regions are at positions other than those of the facial parts included in the main facial region.

### BACKGROUND OF THE INVENTION

1. Field of the Invention

The present invention relates to a method and an apparatus for dividing images into a plurality of smaller regions, when dividing a single image in order to print the image onto a plurality of sheets, for example. The present invention also relates to a program that causes a computer to execute the method for dividing images.

2. Description of the Related Art

DPE stores offer printing services. The printing services involve users bringing silver salt photographic films, on which images have been photographed using cameras, or media, in which images have been recorded by digital cameras, into the DPE stores. The DPE store prints the images onto sheets of photosensitive material or the like, using print generating apparatuses. In these printing services, users may generate prints of standard sizes, such as L (4″×6″) or XL (5″×8″). In addition, particularly favored images may be enlarged and prints of even greater sizes may be generated.

However, large prints are expensive, and print generating apparatuses which are capable of generating large prints are limited in number. For this reason, so-called “divided printing”, in which images which are larger than the size of sheets to be utilized are divided and printed on a plurality of the sheets, is being performed.

When performing divided printing, it is necessary to divide a single image into smaller regions according to division numbers such as 2×2 and 3×3. However, if the borders of the smaller regions are at important locations, such as the face of a person who is pictured in the image, the face will be segmented by the division.

For this reason, a divided printing method that takes pasting of an image after generating a print on a plurality of sheets into consideration, wherein a division region and the positions of the borders of the smaller regions are specified by manual operations, has been disclosed in U.S. Pat. No. 5,666,471. Another divided printing method, wherein the sizes of the sheets to be utilized and of overlapping portions for pasting are determined according to the sizes of images to be printed, has been disclosed in Japanese Unexamined Patent Publication No. 2000-238364. Still another divided printing method, wherein monotonous image regions, at which changes in images are comparatively small, are detected and the borders of the smaller regions are determined such that they are positioned at the monotonous image regions, has been disclosed in Japanese Unexamined Patent Publication No. 2001-309161.

However, it is necessary to set the division region and the boundaries of the smaller regions manually in the method disclosed in U.S. Pat. No. 5,666,471, and therefore the burden on users is great. The method disclosed in Japanese Unexamined Patent Publication No. 2000-238364 only determines the sizes of overlapping portions for pasting. Therefore, there are cases in which the overlapping portions coincide with important regions of an image, such as faces pictured therein. The method disclosed in Japanese Unexamined Patent Publication No. 2001-309161 does not assume that images are to be divided such that the smaller regions are of a uniform size. Therefore, this method cannot be applied to cases in which images are to be divided into smaller regions of a uniform size. In addition, in the case that there are no monotonous image regions within images, the borders of the smaller regions cannot be determined appropriately.

### SUMMARY OF THE INVENTION

The present invention has been developed in view of the foregoing circumstances. It is an object of the present invention to divide images into smaller regions of a uniform size for divided printing, for example, such that segmentation of faces pictured therein, and facial parts, such as eyes, mouths, and noses, is avoided.

A first image dividing apparatus of the present invention is an image dividing apparatus for dividing an image that includes at least one face pictured therein into a plurality of smaller regions having a uniform size, comprising:

division number specifying means, for receiving specification of the number of smaller regions into which the image is to be divided;

facial region detecting means, for detecting at least one facial region within the image;

first division setting means, for setting a division region and division locations such that the boundaries of the smaller regions are at positions other than that of a main facial region;

facial part detecting means, for detecting facial parts included in the main facial region;

second division setting means, for setting a division region and division locations such that the boundaries of the smaller regions are at positions other than those of the facial parts included in the main facial region;

judging means, for judging whether the size of each of the specified number of smaller regions into which the image is to be divided is greater than the size of the main facial region; and

control means, for controlling the first division setting means, the facial part detecting means, and the second division setting means such that in the case that the result of judgment by the judging means is affirmative, the first division setting means sets the division region and the division locations, and in the case that the result of judgment by the judging means is negative, the facial part detecting means detects facial parts and the second division setting means sets the division region and the division locations.

The “facial region” may be a portion of the image that represents the face itself, or a rectangular region that surrounds a face pictured in the image.

In the case that only a single facial region is included in the image, the “main facial region” is the single facial region. In the case that a plurality of facial regions are included in the image, the “main facial region” is a single or a plurality of facial regions selected by a user from among the plurality of facial regions, or a single or a plurality of facial regions selected based on the position and the like thereof.

The “division region” refers to a region of the image which is to be divided into the plurality of smaller regions.

The “division locations” refers to the positions at which the image is divided, that is, the positions of the borders of the smaller regions.

In the first image dividing apparatus of the present invention, a configuration may be adopted wherein the first division setting means sets the division region and the division locations by:

setting a division range constituted by the plurality of smaller regions to an initial size, which is the same size as the size of the entire image, and decreasing the size in stepwise increments to a final size, at which the widths and heights of the smaller regions are less than or equal to those of the main facial region;

scanning the division range of each size on the image from a scanning initiation position to a scanning completion position;

calculating evaluation scores based on the area of blank regions of the division range that run off the image, the number of instances that the boundaries of the smaller regions segment the main facial region, and the area of the division range; and

setting the division range and the boundaries of the smaller regions at the scanning position where the evaluation score is minimal as the division region and the division locations.

In the first image dividing apparatus of the present invention, a configuration may be adopted wherein the second division setting means sets the division region and the division locations, by:

setting a division range constituted by the plurality of smaller regions to an initial size, which is the same size as the size of the entire image, and decreasing the size in stepwise increments to a final size, at which the widths and heights of the smaller regions are less than or equal to those of the main facial region;

scanning the division range of each size on the image from a scanning initiation position to a scanning completion position;

calculating evaluation scores based on the area of blank regions of the division range that run off the image, the number of instances that the boundaries of the smaller regions segment the facial parts, and the area of the division range; and

setting the division range and the boundaries of the smaller regions at the scanning position where the evaluation score is minimal as the division region and the division locations.

The “facial parts” refer to structural components of faces, such as eyes, noses, mouths, and the like.

A configuration may be adopted wherein the first image dividing apparatus of the present invention further comprises:

main facial region selecting means, for selecting a main facial region from among a plurality of facial regions, in the case that a plurality of facial regions are included in the image.

A configuration may be adopted, wherein the first image dividing apparatus of the present invention further comprises:

main facial region selection receiving means, for receiving input of selection of a main facial region from among a plurality of facial regions, in the case that a plurality of facial regions are included in the image.

A configuration may be adopted, wherein the first image dividing apparatus of the present invention further comprises:

display means, for displaying the boundaries that represent the set division region and the set division locations; and

correction command receiving means, for receiving commands to correct at least one of the division number, the division region, and the division locations.

A second image dividing apparatus of the present invention is an image dividing apparatus for dividing an image that includes at least one face pictured therein into a plurality of smaller regions having a uniform size, comprising:

facial region detecting means, for detecting at least one facial region within the image; and

division setting means, for setting a division region and division locations such that the boundaries of the smaller regions are at positions other than that of a main facial region.

A configuration may be adopted wherein the second image dividing apparatus of the present invention further comprises:

facial part detecting means, for detecting facial parts included in the main facial region; and wherein

the division setting means sets the division region and the division locations such that the boundaries of the smaller regions are at positions other than those of the facial parts included in the main facial region.

In the second image dividing apparatus of the present invention, a configuration may be adopted wherein the division setting means sets the division region and the division locations by:

setting a division range constituted by the plurality of smaller regions to an initial size, which is the same size as the size of the entire image, and decreasing the size in stepwise increments to a final size, at which the widths and heights of the smaller regions are less than or equal to those of the main facial region;

scanning the division range of each size on the image from a scanning initiation position to a scanning completion position;

calculating evaluation scores based on the area of blank regions of the division range that run off the image, the number of instances that the boundaries of the smaller regions segment the main facial region, and the area of the division range; and

setting the division range and the boundaries of the smaller regions at the scanning position where the evaluation score is minimal as the division region and the division locations.

In the second image dividing apparatus of the present invention, a configuration may be adopted wherein the division setting means sets the division region and the division locations by:

setting a division range constituted by the plurality of smaller regions to an initial size, which is the same size as the size of the entire image, and decreasing the size in stepwise increments to a final size, at which the widths and heights of the smaller regions are less than or equal to those of the main facial region;

scanning the division range of each size on the image from a scanning initiation position to a scanning completion position;

calculating evaluation scores based on the area of blank regions of the division range that run off the image, the number of instances that the boundaries of the smaller regions segment the facial parts, and the area of the division range; and

setting the division range and the boundaries of the smaller regions at the scanning position where the evaluation score is minimal as the division region and the division locations.

A configuration may be adopted wherein the second image dividing apparatus of the present invention further comprises:

division number setting means, for setting the number of smaller regions into which the image is to be divided such that the sizes of the smaller regions are greater than the size of the main facial region; and wherein

the division setting means sets the division region and the division locations according to the set division number.

A configuration may be adopted wherein the second image dividing apparatus of the present invention further comprises:

division number specifying means, for receiving specification of the number of smaller regions into which the image is to be divided; and wherein

the division setting means sets the division region and the division locations according to the specified division number.

A configuration may be adopted wherein the second image dividing apparatus of the present invention further comprises:

main facial region selecting means, for selecting a main facial region from among a plurality of facial regions, in the case that a plurality of facial regions are included in the image.

A configuration may be adopted wherein the second image dividing apparatus of the present invention further comprises:

main facial region selection receiving means, for receiving input of selection of a main facial region from among a plurality of facial regions, in the case that a plurality of facial regions are included in the image.

A configuration may be adopted wherein the second image dividing apparatus of the present invention further comprises:

display means, for displaying the boundaries that represent the set division region and the set division locations; and

correction command receiving means, for receiving commands to correct at least one of the division number, the division region, and the division locations.

A third image dividing apparatus of the present invention is an image dividing apparatus for dividing an image that includes at least one face pictured therein into a plurality of smaller regions having a uniform size, comprising:

facial region detecting means, for detecting at least one facial region within the image;

facial part detecting means, for detecting facial parts included in the at least one facial region; and

division setting means, for setting a division region and division locations such that the boundaries of the smaller regions are at positions other than those of the facial parts included in the at least one facial region.

In the third image dividing apparatus of the present invention, a configuration may be adopted wherein the division setting means sets the division region and the division locations by:

setting a division range constituted by the plurality of smaller regions to an initial size, which is the same size as the size of the entire image, and decreasing the size in stepwise increments to a final size, at which the widths and heights of the smaller regions are less than or equal to those of the main facial region;

scanning the division range of each size on the image from a scanning initiation position to a scanning completion position;

calculating evaluation scores based on the area of blank regions of the division range that run off the image, the number of instances that the boundaries of the smaller regions segment the facial parts, and the area of the division range; and

setting the division range and the boundaries of the smaller regions at the scanning position where the evaluation score is minimal as the division region and the division locations.

A configuration may be adopted wherein the third image dividing apparatus of the present invention further comprises:

division number specifying means, for receiving specification of the number of smaller regions into which the image is to be divided; and wherein

the division setting means sets the division region and the division locations according to the specified division number.

A configuration may be adopted wherein the third image dividing apparatus of the present invention further comprises:

display means, for displaying the boundaries that represent the set division region and the set division locations; and

correction command receiving means, for receiving commands to correct at least one of the division number, the division region, and the division locations.

A first image dividing method of the present invention is an image dividing method for dividing an image that includes at least one face pictured therein into a plurality of smaller regions having a uniform size, comprising the steps of:

receiving specification of the number of smaller regions into which the image is to be divided;

detecting at least one facial region within the image;

judging whether the size of each of the specified number of smaller regions into which the image is to be divided is greater than the size of the main facial region; and

setting a division region and division locations such that the boundaries of the smaller regions are at positions other than that of a main facial region in the case that the result of judgment is affirmative, while detecting facial parts included in the main facial region and setting a division region and division locations such that the boundaries of the smaller regions are at positions other than those of the facial parts included in the main facial region in the case that the result of judgment is negative.

A second image dividing method of the present invention is an image dividing method for dividing an image that includes at least one face pictured therein into a plurality of smaller regions having a uniform size, comprising the steps of:

detecting at least one facial region within the image; and

setting a division region and division locations such that the boundaries of the smaller regions are at positions other than that of a main facial region.

A third image dividing method of the present invention is an image dividing method for dividing an image that includes at least one face pictured therein into a plurality of smaller regions having a uniform size, comprising the steps of:

detecting at least one facial region within the image;

detecting facial parts included in the at least one facial region; and

setting a division region and division locations such that the boundaries of the smaller regions are at positions other than those of the facial parts included in the at least one facial region.

Note that the first through third image dividing methods of the present invention may be provided as programs that cause computers to execute the methods.

The image dividing programs of the present invention may be provided being recorded on computer readable media. Those who are skilled in the art would know that computer readable media are not limited to any specific type of device, and include, but are not limited to: floppy disks; RAM's; ROM's; CD's; magnetic tapes; hard disks; and internet downloads, by which computer instructions may be transmitted. Transmission of the computer instructions through a network or through wireless transmission means is also within the scope of the present invention. In addition, the computer instructions may be in the form of object, source, or executable code, and may be written in any language, including higher level languages, assembly language, and machine language.

In the first image dividing apparatus and the first image dividing method, specification of the number of smaller regions into which the image is to be divided is received; at least one facial region within the image is detected; and whether the size of each of the specified number of smaller regions into which the image is to be divided is greater than the size of the main facial region is judged. In the case that the result of judgment is affirmative, the division region and the division locations are set such that the boundaries of the smaller regions are at positions other than that of a main facial region. Thereby, segmentation of the main facial region included in the image is avoided as much as possible, in the case that the image is divided according to the set division region and the set division locations.

On the other hand, in the case that the result of judgment is negative, facial parts included in the main facial region are detected, and the division region and the division locations are set such that the boundaries of the smaller regions are at positions other than those of the facial parts included in the main facial region. Thereby, segmentation of the main facial region included in the image may occur, but segmentation of the facial parts included in the main facial region is avoided as much as possible, in the case that the image is divided according to the set division region and the set division locations.

A configuration may be adopted, wherein the division region and the division locations are set by: setting a division range constituted by the plurality of smaller regions to an initial size, which is the same size as the size of the entire image, and decreasing the size in stepwise increments to a final size, at which the widths and heights of the smaller regions are less than or equal to those of the main facial region; scanning the division range of each size on the image from a scanning initiation position to a scanning completion position; calculating evaluation scores based on the area of blank regions of the division range that run off the image, the number of instances that the boundaries of the smaller regions segment the main facial region, and the area of the division range; and setting the division range and the boundaries of the smaller regions at the scanning position where the evaluation score is minimal as the division region and the division locations. In this case, the division region and the division locations can be set appropriately, based on the evaluation scores.

A configuration may be adopted, wherein the division region and the division locations are set by: setting a division range constituted by the plurality of smaller regions to an initial size, which is the same size as the size of the entire image, and decreasing the size in stepwise increments to a final size, at which the widths and heights of the smaller regions are less than or equal to those of the main facial region; scanning the division range of each size on the image from a scanning initiation position to a scanning completion position; calculating evaluation scores based on the area of blank regions of the division range that run off the image, the number of instances that the boundaries of the smaller regions segment the facial parts, and the area of the division range; and setting the division range and the boundaries of the smaller regions at the scanning position where the evaluation score is minimal as the division region and the division locations. In this case also, the division region and the division locations can be set appropriately, based on the evaluation scores.

In the case that an image includes a plurality of faces, segmentation of a main facial region can be positively prevented, by selecting the main facial region from among a plurality of facial regions that represent the plurality of faces.

In the case that an image includes a plurality of faces, segmentation of a main facial region designated by a user can be positively prevented, by receiving input of selection of a main facial region from among a plurality of facial regions.

Users are enabled to reset the division regions and/or the division locations, in the case that the boundaries that represent the set division region and the set division locations are displayed; and correction of at least one of the division number, the division region, and the division locations is enabled.

In the second image dividing apparatus and the second image dividing method, at least one facial region within the image is detected; and the division region and the division locations are set such that the boundaries of the smaller regions are at positions other than that of a main facial region. Thereby, segmentation of the main facial region included in the image is avoided as much as possible, in the case that the image is divided according to the set division region and the set division locations.

Segmentation of the facial parts included in the main facial region can be avoided as much as possible, in the case that the facial parts included in the main facial region are detected; the division region and the division locations are set such that the boundaries of the smaller regions are at positions other than those of the facial parts included in the main facial region; and the image is divided according to the set division region and the set division locations.

The smaller regions can be set such that the main facial region is fitted therein, by: setting the number of smaller regions into which the image is to be divided such that the sizes of the smaller regions are greater than the size of the main facial region; and setting the division region and the division locations according to the set division number. In this case, segmentation of the main facial region can be positively prevented.

In the third image dividing apparatus and the third image dividing method of the present invention, at least one facial region within the image is detected; facial parts included in the at least one facial region are detected; and the division region and the division locations are such that the boundaries of the smaller regions are at positions other than those of the facial parts included in the at least one facial region. Thereby, segmentation of the facial parts included in the main facial region is avoided as much as possible, in the case that the image is divided according to the set division region and the set division locations.

### BRIEF DESCRIPTION OF THE DRAWINGS

FIG. 1 is a schematic block diagram that illustrates the construction of an image dividing apparatus according to a first embodiment of the present invention.

FIG. 2 is a flow chart that illustrates the processes performed by the image dividing apparatus of the first embodiment.

FIG. 3 illustrates a division number input screen.

FIG. 4 is a first diagram for explaining a standard division process.

FIGS. 5A, 5B, and 5C are diagrams for explaining selection of main facial regions.

FIGS. 6A, 6B, and 6C are second diagrams for explaining the standard division process.

FIG. 7 is a flow chart that illustrates a non-segmenting division process of the first embodiment.

FIG. 8 is a diagram for explaining a division range and division blocks.

FIGS. 9A and 9B are diagrams for explaining raster scanning.

FIG. 10 is a diagram for explaining calculation of evaluation scores in a first division process.

FIG. 11 is a first diagram for explaining reduction of the division range.

FIG. 12 is a diagram for explaining calculation of evaluation scores in a second division process.

FIG. 13 is a second diagram for explaining reduction of the division range.

FIGS. 14A, 14B, and 14C are diagrams that illustrate the results of non-segmenting division processes.

FIGS. 15A, 15B, and 15C illustrate the results of standard division processes.

FIG. 16 is a diagram that illustrates an example of the division result display screen.

FIG. 17 is a schematic block diagram that illustrates the construction of an image dividing apparatus according to a second embodiment of the present invention.

FIG. 18 is a flow chart that illustrates a non-segmenting division process of the second embodiment.

FIG. 19 is a schematic block diagram that illustrates the construction of an image dividing apparatus according to a third embodiment of the present invention.

FIG. 20 is a flow chart that illustrates a non-segmenting division process of the third embodiment.

FIG. 21 is a schematic block diagram that illustrates the construction of an image dividing apparatus according to a fourth embodiment of the present invention.

FIG. 22 is a flow chart that illustrates a division number setting process of the fourth embodiment.

FIG. 23 is a diagram that illustrates division number ID's.

FIG. 24 is a diagram for explaining the setting of division numbers.

FIG. 25 is a schematic block diagram that illustrates the construction of an image dividing apparatus according to a fifth embodiment of the present invention.

FIG. 26 is a flow chart that illustrates a non-segmenting division process of the fifth embodiment.

### BEST MODE FOR CARRYING OUT THE INVENTION

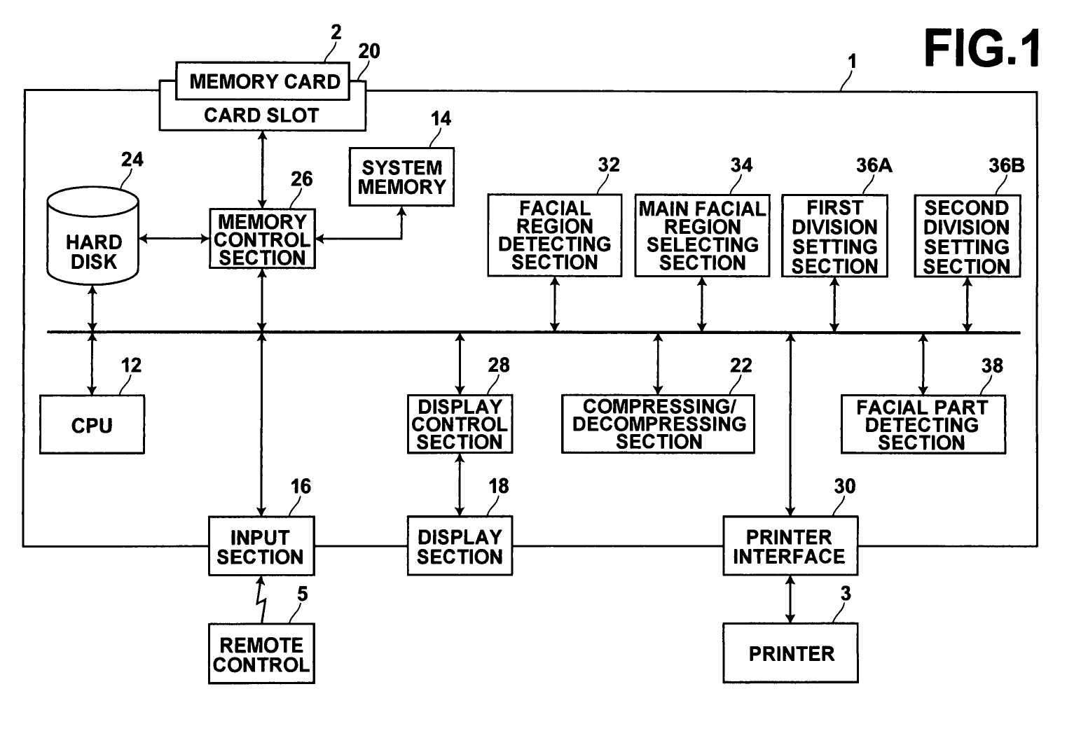

Hereinafter, embodiments of the present invention will be described in detail with reference to the attached drawings. FIG. 1 is a schematic block diagram that illustrates the construction of an image dividing apparatus 1 (hereinafter, simply referred to as “apparatus 1”) according to a first embodiment of the present invention. As illustrated in FIG. 1, the apparatus 1 comprises: a CPU 12, for controlling recording, display, and other aspects of image data sets that represent images, as well as the various components of the apparatus 1; a system memory 14 that includes a ROM, in which programs for operating the apparatus 1 and various constants are recorded, and a RAM, which becomes a workspace when the CPU executes processes; an input section 16 constituted by an IR sensor, for example, for receiving input of commands to the apparatus 1 from a remote control 5; and a display section 18, constituted by an LCD monitor or the like. Note that the input section 16 may be constituted by a keyboard and a mouse, or by a touch panel screen or the like. In addition, it is not necessary for the display section 18 to be provided on the apparatus 1, and may be an external monitor, such as a television, which is connectable to the apparatus.

The image dividing apparatus 1 further comprises: a card slot 20, for reading image data sets out of a memory card 2 in which image data sets are recorded and for recording image data sets into the memory card 2; a compressing/decompressing section 22, for compressing image data sets in formats such as JPEG and for decompressing compressed image data sets; a hard disk 24, in which image data sets read out from the memory card 2 and programs to be executed by the CPU such as viewer software for viewing images, are recorded; a memory control section 26, for controlling the system memory 14, the card slot 20, and the hard disk 24; a display control section 28, for controlling display by the display section 18; and a printer interface 30, for connecting a printer 3 to the image dividing apparatus 1.

The image dividing apparatus 1 still further comprises: a facial region detecting section 32, for detecting facial regions from within a processing target image; a main facial region selecting section 34, for selecting a main facial region from among the detected facial regions; a first and a second division setting section 36A and 36B, for setting division regions and division locations within the processing target image; and a facial part detecting section 38, for detecting facial parts (eyes, noses and mouths) included in faces.

Hereinafter, the functions of the facial region detecting section 32, the main facial region selecting section 34, the first and second division setting sections 36A and 36B, and the facial part detecting section 38 will be described in combination with processes which are performed by the apparatus 1 of the first embodiment. Note that it is assumed that image data sets, which are recorded in the memory card 2, have been read out by the card slot 20 and are stored in the hard disk 24.

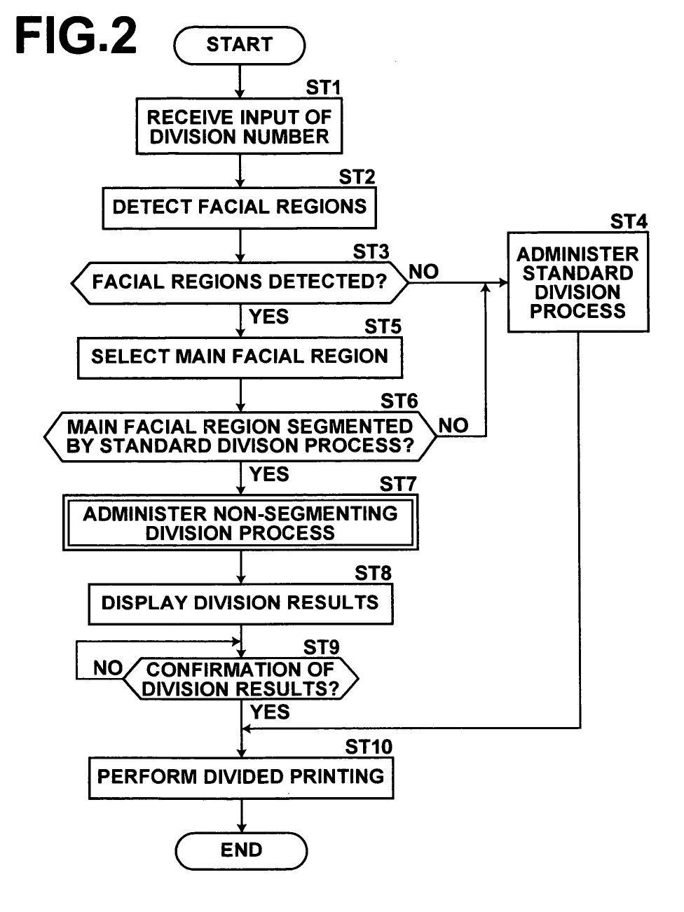

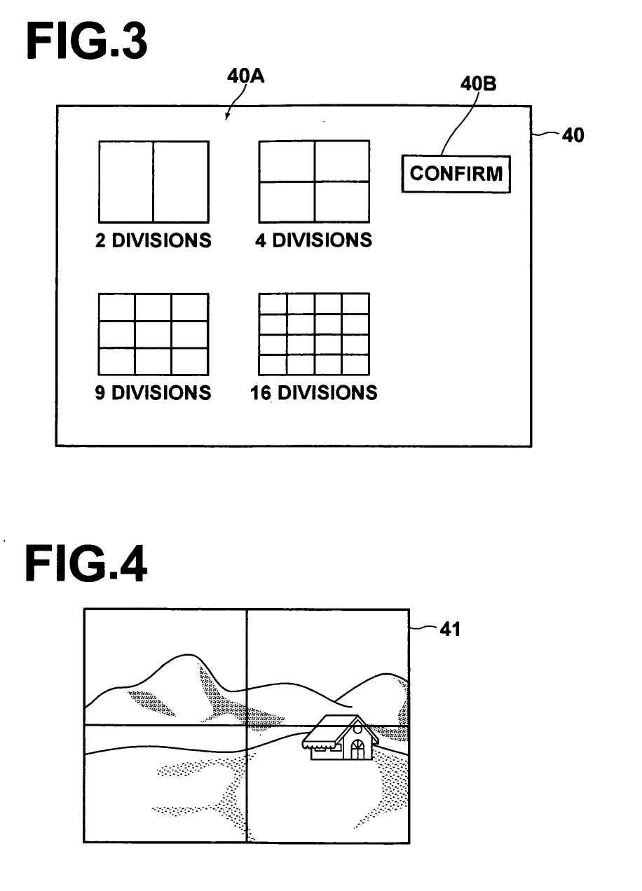

FIG. 2 is a flow chart that illustrates the processes performed by the apparatus 1 of the first embodiment. Note that the flow chart of FIG. 2 illustrates the processes following user selection of an image to be divided from among images which are stored in the hard disk 24 and displayed by the display section 18. The CPU 12 initiates processing when a user inputs selection of the image to be divided. First, input of a division number (number of smaller regions into which the image is to be divided) by the user is received (step ST1). FIG. 3 illustrates a division number input screen 40, for receiving input of a division number. As illustrated in FIG. 3, the division number input screen 40 comprises: a plurality of templates 40A that represent division numbers; and a “CONFIRM” button 40B, for confirming the division number selected by the user. As illustrated in FIG. 3, examples of the templates 40A are: two divisions; four divisions, nine divisions, and sixteen divisions. The user selects a desired template by operating the remote control 5, then inputs the selected template to the apparatus 1 by selecting the “CONFIRM” button 40B. Thereby, the division number represented by the selected template is input to the apparatus 1.

When the division number has been input, the facial region detecting section 32 detects facial regions, which are included in the image selected by the user (hereinafter, referred to as “processing target image”) (step ST2). Note that skin colored regions in the shape of a human face (oval, for example) may be detected from the image and extracted as facial regions, as a method of extracting facial regions. Alternatively, the facial region extracting methods disclosed in Japanese Unexamined Patent Publication Nos. 8(1996)-153187, 9(1997)-50528, 2001-14474, 2001-175868, and 2001-209795 or other known methods may be employed.

Thereafter, the CPU 12 judges whether the facial region detecting section 32 was able to detect any facial regions within the processing target image, that is, whether the processing target image includes facial regions (step ST3). In the case that the result of judgment in step ST3 is negative, the entirety of the processing target image is divided according to the division number received in step ST1 (step ST4). This division process is referred to as a “standard division process”. Note that here, it is assumed that the division number input at step ST1 is 4. As illustrated in FIG. 4, the entirety of a processing target image 41 that does not picture any human subjects therein is simply divided according to the input division number. When the division performed in step ST4 is completed, the process proceeds to step ST10, to be described later.

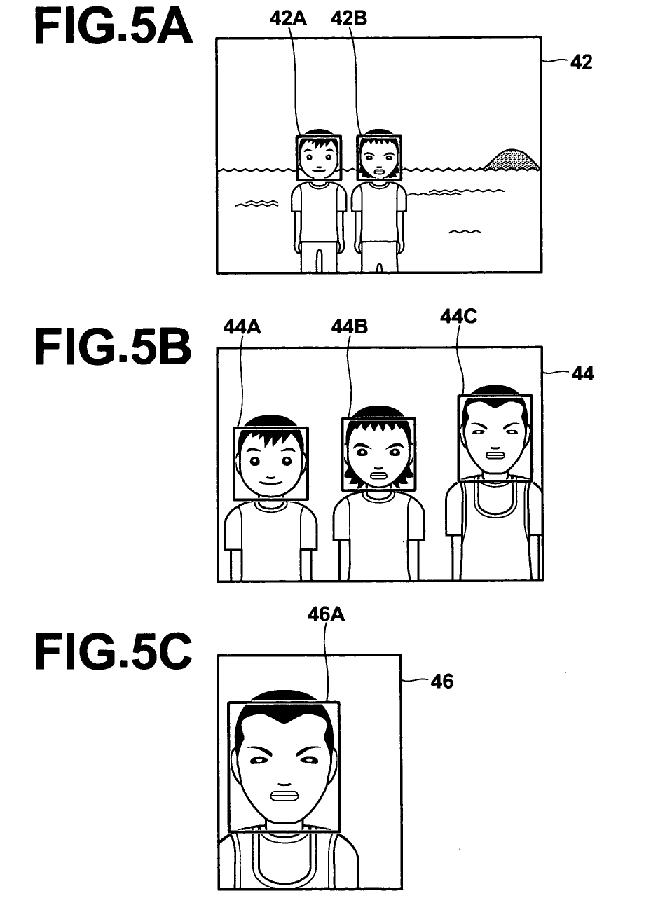

In the case that the result of judgment in step ST3 is affirmative, the main facial region selecting section 34 selects a main facial region from among the facial regions included in the processing target image (step ST5). FIGS. 5A, 5B, and 5C are diagrams for explaining selection of the main facial region. In the case that the processing target image includes two faces, such as image 42 illustrated in FIG. 5A, two facial regions 42A and 42B are detected. In this case, the facial region 42B is selected as the main facial region from between the facial regions 42A and 42B, because it is positioned at the approximate center of the image.

In the case that the processing target image includes three faces, such as image 44 illustrated in FIG. 5B, three facial regions 44A, 44B, and 44C are detected. In this case, the facial region 44B is selected as the main facial region from among the facial regions 44A, 44B, and 44C, because it is positioned between the two other facial regions 44A and 44C.

In the case that the processing target image includes a single image, such as image 45 illustrated in FIG. 5C, a single facial region 46A is detected. Therefore, the facial region 46A is selected as the main facial region.

Note that the detected facial regions may be visibly displayed by the display section 18, and the user may select the main facial region by operating the remote control 5. In this case, the main facial region selecting section 34 becomes unnecessary.

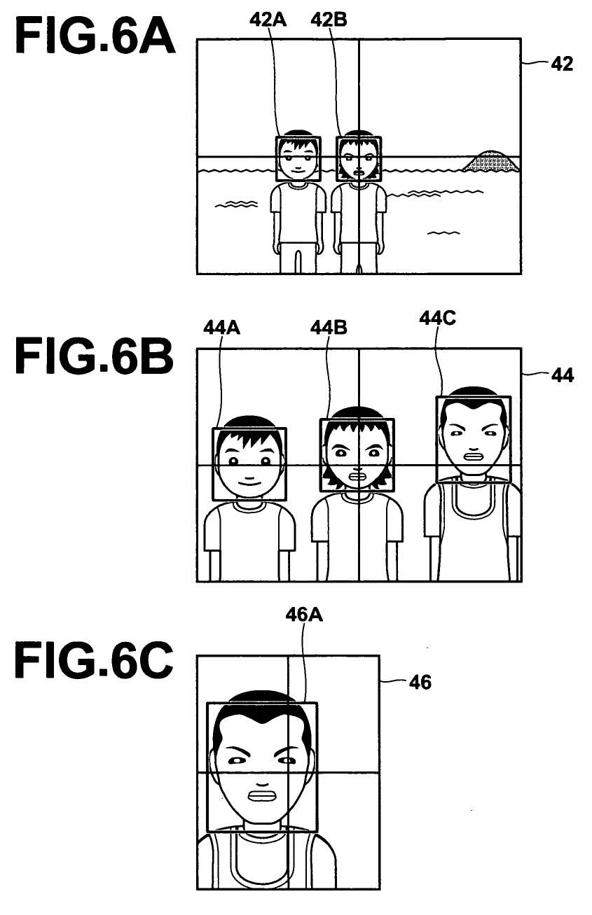

Thereafter, it is judged whether the standard division process would segment the main facial region (step ST6). This is judged by determining whether the division locations by the standard division process would be positioned within the main facial region. Here, if the images 42, 44, and 46 illustrated in FIG. 5 are divided by the standard division process using four as the division number, the main facial regions 42B, 44B, and 46A thereof will all be segmented, as illustrated in FIGS. 6A, 6B, and 6C.

In the case that the result of judgment in step ST6 is negative, the process returns to step ST4, and the standard division process is administered. In the case that the result of judgment in step ST6 is positive, the processing target image is divided such that the main facial region is not segmented (step ST7). This division process will be referred to as the non-segmenting division process. Hereinafter, the non-segmenting division process will be described.

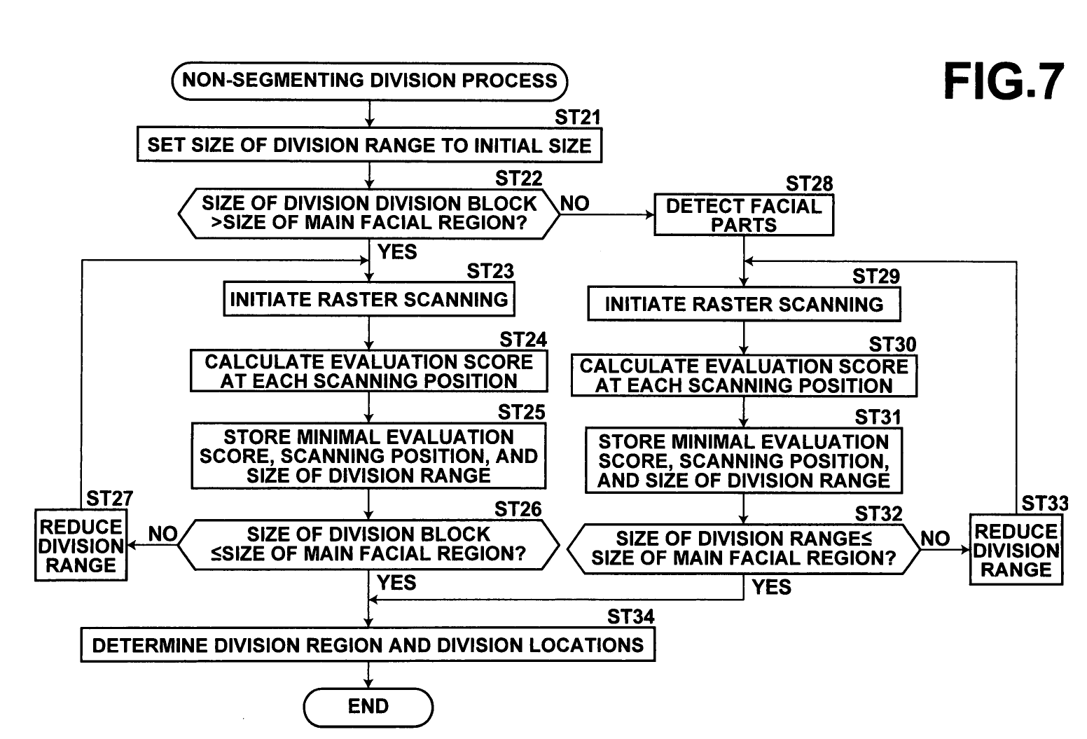

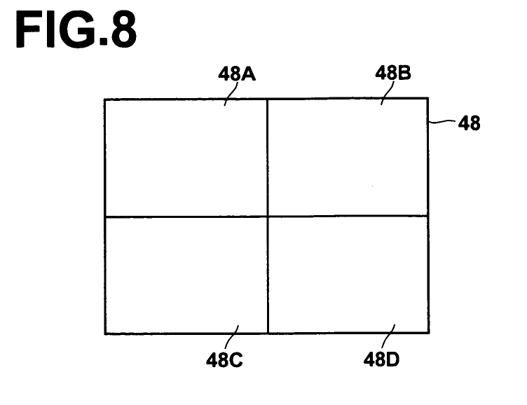

FIG. 7 is a flow chart that illustrates the non-segmenting division process of the first embodiment. In the first embodiment, the processing target image is divided into a plurality of smaller regions according to templates such as those illustrated in FIG. 3. In the case that the division number of a template is four, as in the example illustrated in FIG. 8, the smaller regions which are sectioned by borders are referred to as division blocks 48A through 48D, and the collective body of the division blocks 48A through 48D is referred to as a division range 48.

First, the CPU 12 sets the size of the division range to an initial size (step ST21). The initial size is the same size as that of the processing target image. Next, the CPU 12 judges whether the size of each of the division blocks is greater than the size of the main facial region (step ST22). Here, “the size of each of the division blocks is greater than the size of the main facial region” means that each of the division blocks is of a size that can completely include the main facial region therein. Note that in the case that the processing target image is divided into four smaller regions, if the processing target image is image 42 of FIG. 5A, the size of each of the division blocks is greater than the size of the main facial region. On the other hand, in the case that the processing target image is image 46 of FIG. 5C, the size of each of the division blocks is smaller than the size of the main facial region.

If the result of judgment in step ST22 is affirmative, the first division setting section 36A performs a first division process. First, the first division setting section 36A initiates raster scanning of the division range within a predetermined search range within the processing target region (step ST23).

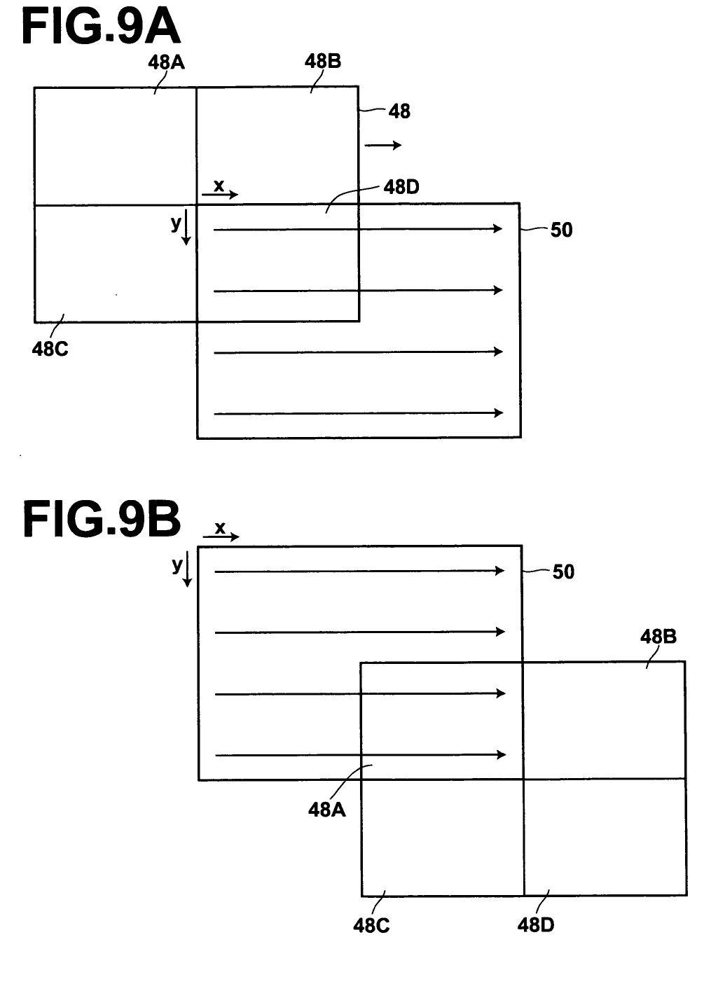

FIGS. 9A and 9B are diagrams for explaining raster scanning. As illustrated in FIG. 9A, the first division setting section 36A sets a coordinate system having the upper left corner of the processing target image 50 as its origin. An x-direction initial scanning position is set to be that at which the left edge of the lower right division block 48D is positioned at the left edge of the processing target image 50. The initial scanning position within the search range is a position at which the upper edge of the lower right division block 48D is positioned at the upper limit of the processing target image 50 at the x-direction initial scanning position.

Next, the first division setting section 36A moves the division range 48 in the x direction 1 pixel at a time, for example, thereby scanning the division range 48 across the processing target image 50 in the x direction. When the right edge of the leftmost division block 48A is positioned at the right edge of the processing target image 50 (x-direction final scanning position), the division range is returned to the x-direction initial scanning position, then moved one pixel in the y direction. Then, the division range 48 is scanned in the x direction to the x-direction final scanning position.

The above processes are repeated until the right edge of the upper left division block 48A is positioned at the right edge of the processing target image 50, and the lower edge of the division block 48A is positioned at the lower edge of the processing target image 50 (scanning completion position within the search range), as illustrated in FIG. 9B. Thereby, the division range 48 is raster scanned within the processing target image 50.

When the raster scanning is completed, the first division setting section 36A reduces the size of the division range 48 while maintaining the aspect ratio thereof, then performs raster scanning of the search range again, as will be described later. Note that a predetermined scaling factor may be employed as the reduction ratio of the division range 48.

The first division setting section 36A calculates evaluation scores H0, for determining the division region and the division locations, at each of the scanning positions (step ST24). FIG. 10 is a diagram for explaining calculation of the evaluation scores in the first division process. Note that in FIG. 10, image 42 of FIG. 5A is the processing target image. As illustrated in FIG. 10, the first division setting section 36A calculates the area H1 of a blank region (referred to as blank region BL) of the division range 48 that runs off the processing target image 42, and a number of instances H2 that the boundaries within the division range 48 segment the main facial region, at each scanning position of the division range 48. Note that the number of segmentations H2 of the main facial region 42B at the scanning position illustrated in FIG. 10 is 2. The evaluation score H0 is calculated at each of the scanning positions according to the following formula (1).
H0=H1+H2+H3 (1)
Note that H3 is the area of the division range 48.

In the first embodiment, scanning positions at which the evaluation score H0 are lower have blank regions BL with smaller areas, fewer segmentations of the main facial region, and division ranges 48 with greater areas. Therefore, scanning positions at which the evaluation score H0 is low enable obtainment of more preferable divided images if the division range 48 at the scanning position is employed to divide the processing target image. For this reason, the first division setting section 36A stores the minimal evaluation score, the scanning position at which the minimal evaluation score was calculated, and the size of the division range with which the scanning was performed in the system memory 14 or the hard disk 24, for each raster scanning of the search range (step ST25). Note that the coordinate position of the center of the division range 48 within the processing target image may be stored in the system memory 14 or the hard disk 24 as the scanning position. When a single raster scan is completed, the first division setting section 36A judges whether the size of each division block is less than or equal to the size of the main facial region (step ST26). If the result of judgment in step ST26 is negative, the division range 48 is reduced (step ST27), the process returns to step ST23, and the steps thereafter are repeated.

Note that the phrase “the size of each division block is less than or equal to the size of the main facial region” refers to a state in which the height of the division block is less than or equal to the height of the main facial region, and the width of the division block is less than or equal to the width of the main facial region.

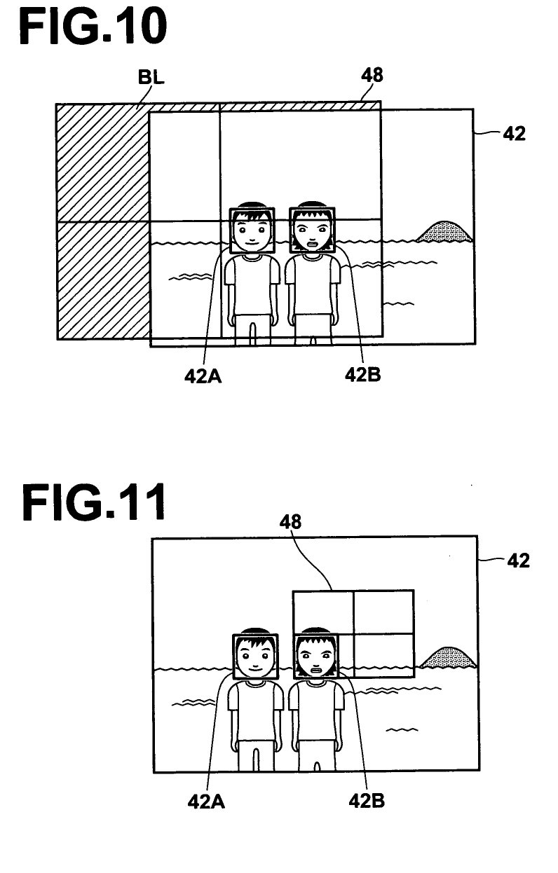

By performing the above steps, the division range 48 is reduced until the division block is inscribed within the main facial region, as illustrated in FIG. 11, and steps ST23 through ST25 are repeated.

Note that from the second and following raster scans, the minimal evaluation score, the scanning position at which the minimal evaluation score was calculated, and the size of the division range with which the minimal evaluation score was calculated are stored in the system memory 14 or the hard disk 24 only in the case that a minimal evaluation score lower than that which is already stored in the system memory 14 or the hard disk 24 is calculated.

If the result of judgment in step ST22 is negative, the facial part detecting section 38 detects facial parts from within the main facial region (step ST28). Note that extraction of facial parts may be performed by scanning a template of a pattern of facial parts comprising eyes, a mouth, and a nose, and designating a position that best matches with the template as the positions of the facial parts. Alternatively, the method disclosed in Japanese Unexamined Patent Publication No. 2000-132688, wherein points at which the probability that facial parts derived by a template matching method, and a probability distribution of facial parts derived by learning sample data, are high are designated as the positions of the facial parts, may be employed. As a further alternative, the method disclosed in Japanese Unexamined Patent Publication No. 2004-78637, wherein the positions of facial parts are determined by extracting edge components from a facial region and taking into consideration the position, size, and geometric characteristics of the face represented thereby, may be employed. As still further alternatives, the method disclosed in Japanese Unexamined Patent Publication 2005-56124 or any other known method may be employed.

Thereafter, the second division setting section 36B performs a second division process. First, the second division setting section 36B initiates raster scanning in a manner similar to that of the first division setting section 36A (step ST29). Note that the search range employed in the raster scanning is the same as that employed by the first division setting section 36A.

When the raster scanning is completed, the second division setting section 36B reduces the size of the division range 48 while maintaining the aspect ratio thereof, then performs raster scanning of the search range again.

The second division setting section 36B calculates evaluation scores H10, for determining the division region and the division locations, at each of the scanning positions (step ST30). FIG. 12 is a diagram for explaining calculation of the evaluation scores in the second division process. Note that in FIG. 12, image 46 of FIG. 5C is the processing target image. As illustrated in FIG. 12, the second division setting section 36B calculates the area H11 of a blank region (referred to as blank region BL) of the division range 48 that runs off the processing target image 46, a number of instances H12 that the boundaries within the division range 48 segment the eyes, a number of instances H13 that the boundaries within the division range 48 segment the mouth, and a number of instances H14 that the boundaries within the division range 48 segment the nose at each scanning position of the division range 48. Note that the number of segmentations H12 of the eyes is 2 for the right eye, 4 for the left eye, the number of segmentations H13 of the mouth is 2, and the number of segmentations H14 of the nose is 0 at the scanning position illustrated in FIG. 12. The evaluation score H10 is calculated at each of the scanning positions according to the following formula (2).
H10=H11+α1×H12+α2×H13+α3×H14−H15 (2)
Note that H15 is the area of the division range 48. Note also that α1, α2, and α3 are weighting coefficients, having the relationship α1>α2>α3.

In the first embodiment, scanning positions at which the evaluation score H10 are lower have blank regions BL with smaller areas, fewer segmentations of the facial parts, and division ranges 48 with greater areas. Therefore, scanning positions at which the evaluation score H10 is low enable obtainment of more preferable divided images if the division range 48 at the scanning position is employed to divide the processing target image. In addition, because the relationship among the weighting coefficients is α1>α2>α3, even if the eyes, mouth, and nose are segmented the same number of times, the evaluation scores increase in the order of segmentation of the nose, segmentation of the mouth, and segmentation of the eyes. That is, cases in which the eyes are segmented result in higher evaluation scores than cases in which the nose and the mouth are segmented. The weighting coefficients are set in this manner, because people are characterized in the order of their eyes, their mouths, and their noses.

For this reason, the second division setting section 36B stores the minimal evaluation score, the scanning position at which the minimal evaluation score was calculated, and the size of the division range with which the scanning was performed in the system memory 14 or the hard disk 24, for each raster scanning of the search range (step ST31). When a single raster scan is completed, the second division setting section 36B judges whether the size of each division block is less than or equal to the size of the main facial region (step ST32). If the result of judgment in step ST32 is negative, the division range 48 is reduced (step ST33), the process returns to step ST29, and the steps thereafter are repeated.

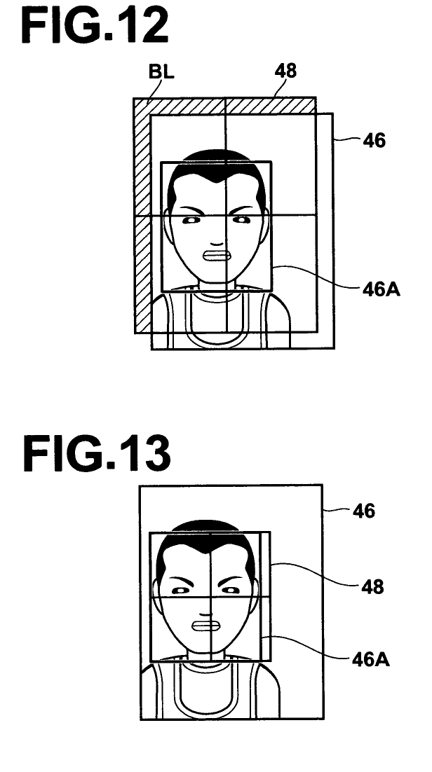

By performing the above steps, the division range 48 is reduced until the division block is inscribed within the main facial region 46A, as illustrated in FIG. 13, and steps ST29 through ST32 are repeated.

Note that from the second and following raster scans, the minimal evaluation score, the scanning position at which the minimal evaluation score was calculated, and the size of the division range with which the minimal evaluation score was calculated are stored in the system memory 14 or the hard disk 24 only in the case that a minimal evaluation score lower than that which is already stored in the system memory 14 or the hard disk 24 is calculated.

When the results of judgment at step ST26 and at step ST32 become affirmative, a region defined by the scanning position and the size of the division range by which the minimal evaluation score was obtained, and which are stored in the system memory 14 or the hard disk 24 are designated as the division region, while the borders of the division range 48 are designated as the division locations (step S34), to complete the non-segmenting division process.

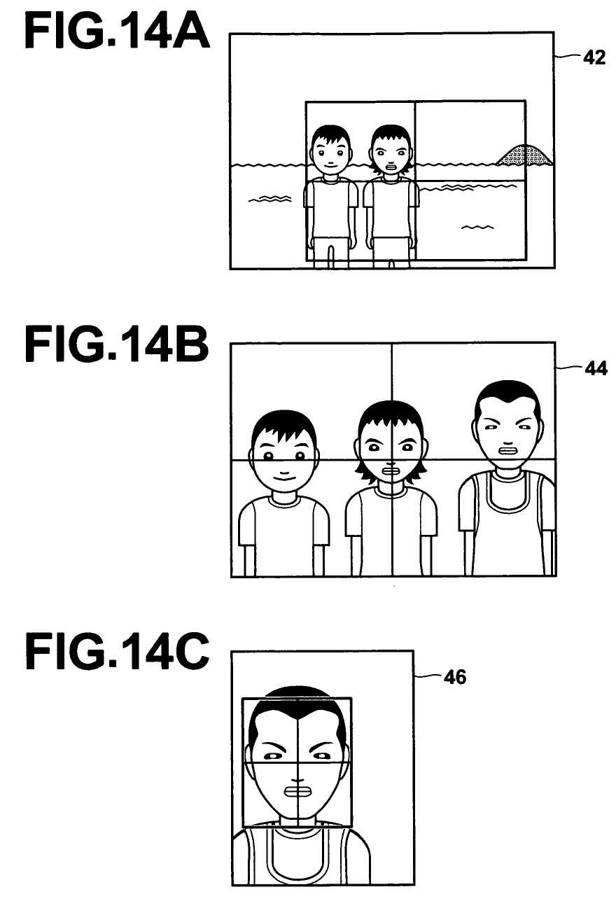

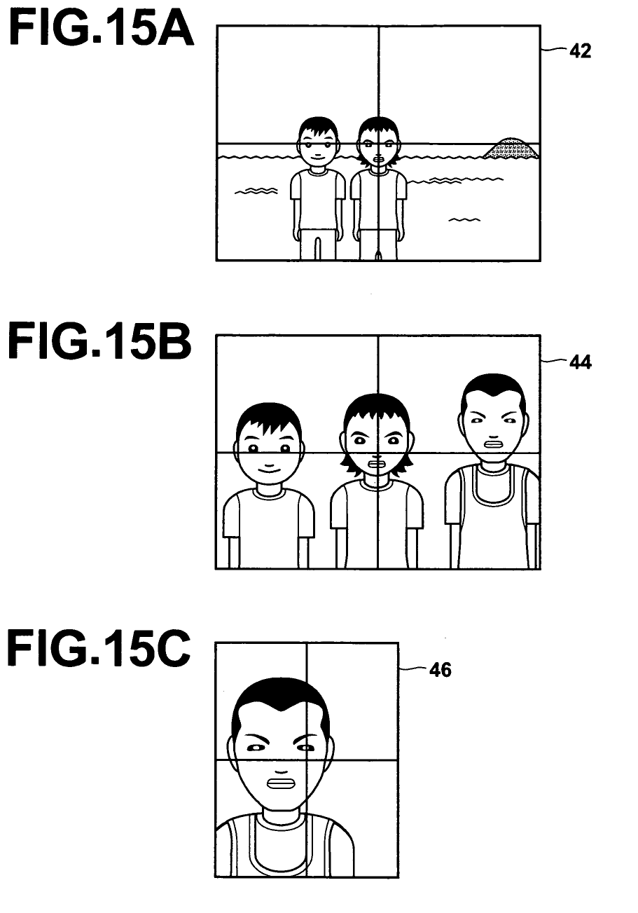

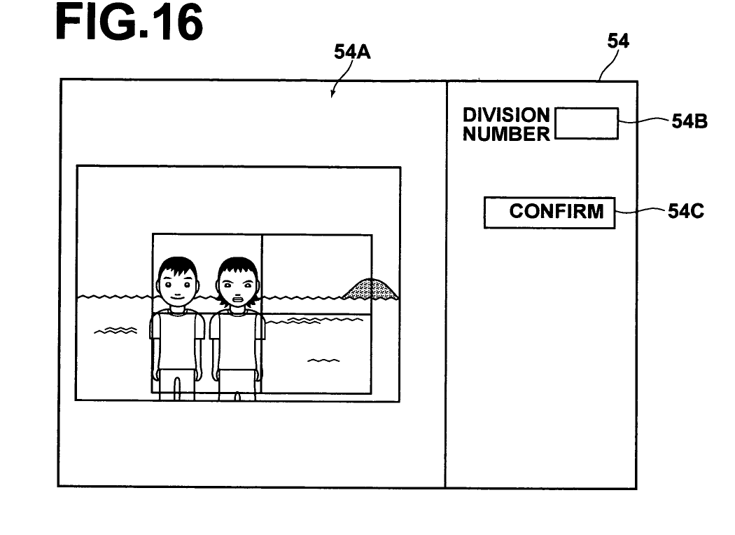

FIGS. 14A, 14B, and 14C are diagrams that illustrate the results of non-segmenting division processes in the case that the division number is 4. FIGS. 14A, 14B, and 14C illustrate the results of the non-segmenting division process for image 42 illustrated in FIG. 5A, image 44 illustrated in FIG. 5B, and image 46 illustrated in FIG. 5C, respectively. FIGS. 15A, 15B, and 15C illustrate the results of standard division processes. FIGS. 15A, 15B, and 15C illustrate the results of the standard division process for image 42 illustrated in FIG. 5A, image 44 illustrated in FIG. 5B, and image 46 illustrated in FIG. 5C, respectively.

In the case that the standard division process is administered on image 42, the face of the person toward the right of the image (corresponding to the main facial region) is segmented into four pieces, and the face of the person toward the left of the image is segmented into two pieces, as illustrated in FIG. 15A. However, if the non-segmenting division process of the first embodiment is administered, the faces of neither person are segmented, as illustrated in FIG. 14A.

As illustrated in FIGS. 14B and 15B, the results of the non-segmenting division process and the standard division process do not differ much in the case of image 44.

As illustrated in FIG. 15C, if the standard division process is administered on image 46, the eyes, mouth, and the nose of the person pictured in the image are all segmented. However, if the non-segmenting division process of the first embodiment is administered, only the nose and the mouth are segmented, as illustrated in FIG. 14C.

Returning to FIG. 2, the CPU 12 causes the display section 18 to display the division results (step ST8). That is, the division region and the borders of the division locations are superposed on the processing target image and displayed by the display section 18. FIG. 16 is a diagram that illustrates an example of the division result display screen. As illustrated in FIG. 16, the division result display screen 54 comprises: a result display area 54A; a division number input area 54B, for inputting a different division number; and a “CONFIRM” button 54C, for confirming input of a different division number and different division locations.

In the case that the user wishes to change the division number, the user inputs a desired division number into the division number input area 54B of the division result display screen 54. The user may also change the size of the division region and the division locations while viewing the division result display screen 54, by employing the remote control 5. Thereafter, the newly input division number, the changed size of the division region and the changed division locations can be confirmed, by selecting the “CONFIRM” button 54C. Note that the user may select the “CONFIRM” button 54C without changing the division number, the size of the division region, or the division locations.

The CPU 12 initiates monitoring regarding whether the user has confirmed the division number, the division region, and the division locations, by selecting the “CONFIRM” button 54C (step ST9). That is, the CPU 12 monitors whether the user has confirmed the division results. If monitoring at step ST9 results in an affirmative result, divided printing of smaller regions is performed according to the confirmed division region and the division locations (step ST10), and the process ends.

In this manner, whether the size of each of the division blocks according to the specified division number is greater than the size of the main facial region is judged. In the case that the result of judgment is affirmative, the division region and the division locations are set such that the boundaries within the division range 48 are at positions other than that of the main facial region. Thereby, segmentation of the main facial region included in the image is avoided as much as possible, in the case that the image is divided according to the set division region and the set division locations.

On the other hand, in the case that the result of judgment is negative, facial parts included in the main facial region are detected, and the division region and the division locations are set such that the boundaries within the division range 48 are at positions other than those of the facial parts included in the main facial region. Thereby, segmentation of the main facial region included in the image may occur, but segmentation of the facial parts included in the main facial region is avoided as much as possible, in the case that the image is divided according to the set division region and the set division locations.

In the case that an image includes a plurality of faces, segmentation of a main facial region can be positively prevented, by selecting the main facial region from among a plurality of facial regions that represent the plurality of faces.

Users are enabled to reset the division regions and/or the division locations to desired division regions and/or division locations, by correction of at least one of the division number, the division region, and the division locations being enabled.

Note that in the first embodiment described above, the first and second division setting sections 36A and 36B are provided as separate components. Alternatively, a single division setting section that performs the functions of both the first and second division setting sections 36A and 36B may be provided.

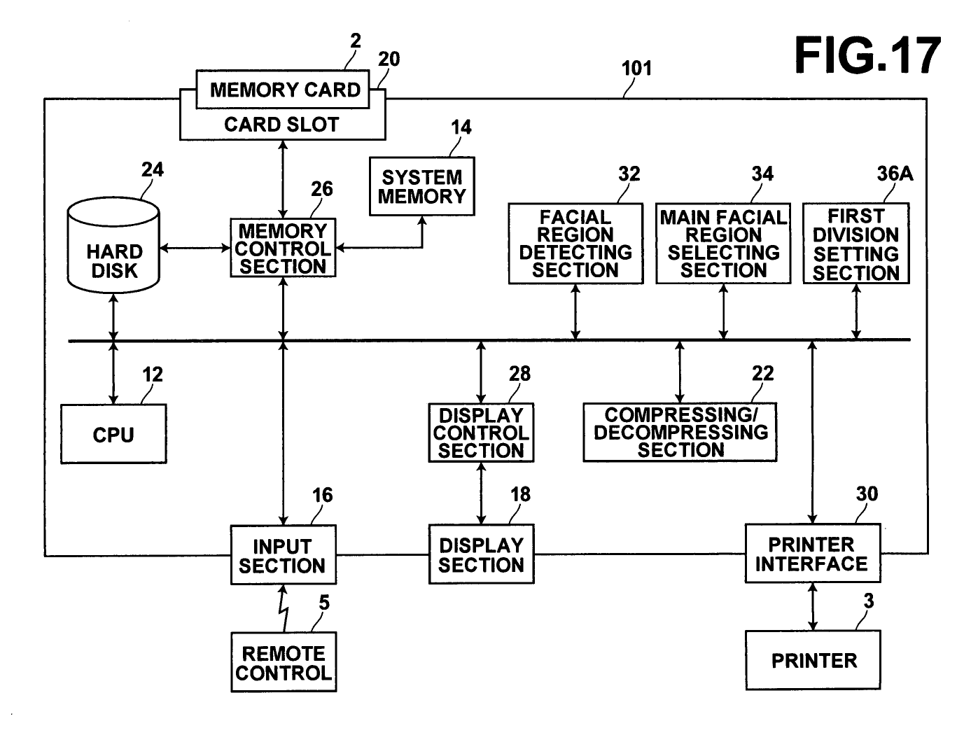

Next, a second embodiment of the present invention will be described. FIG. 17 is a schematic block diagram that illustrates the construction of an image dividing apparatus 101 (hereinafter, simply referred to as “apparatus 101”) according to the second embodiment of the present invention. Note that structural components of the apparatus 101 of the second embodiment which are the same as those of the apparatus 1 of the first embodiment will be denoted with the same reference numerals, and detailed descriptions thereof will be omitted. The apparatus 101 of the second embodiment is the same as the apparatus 1 of the first embodiment, except that the second division setting section 36B and the facial part detecting section 38 have been omitted.

Hereinafter, the processes performed by the apparatus 101 of the second embodiment will be described. Note that only the content of the non-segmenting division process performed by the apparatus 101 of the second embodiment differs from the processes performed by the apparatus 1 of the first embodiment. Therefore, here, only the non-segmenting division process performed by the apparatus 101 of the second embodiment will be described.

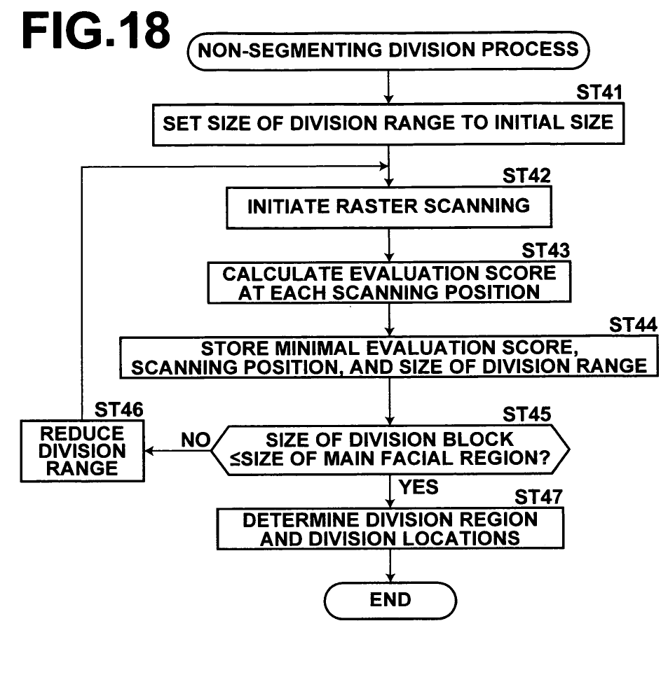

FIG. 18 is a flow chart that illustrates the non-segmenting division process performed by the apparatus 101 of the second embodiment. First, the CPU 12 sets the size of the division range to an initial size (step ST41). Next, the first division setting section 36A performs a first division process. In the first division process, first, the first division setting section 36A initiates raster scanning of a predetermined search range within a processing target image, in a manner similar to that of the first embodiment (step ST42).

The first division setting section 36A calculates evaluation scores at each scanning position of the aforementioned raster scanning according to Formula (1) (step S43). The first division setting section 36A stores the minimal evaluation score, the scanning position at which the minimal evaluation score was calculated, and the size of the division range with which the scanning was performed in the system memory 14 or the hard disk 24, for each raster scanning of the search range (step ST44). When a single raster scan is completed, the first division setting section 36A judges whether the size of each division block is less than or equal to the size of the main facial region (step ST45). If the result of judgment in step ST45 is negative, the division range 48 is reduced (step ST46), the process returns to step ST42, and the steps thereafter are repeated.

Note that from the second and following raster scans, the minimal evaluation score, the scanning position at which the minimal evaluation score was calculated, and the size of the division range with which the minimal evaluation score was calculated are stored in the system memory 14 or the hard disk 24 only in the case that a minimal evaluation score lower than that which is already stored in the system memory 14 or the hard disk 24 is calculated.

When the result of judgment at step ST45 becomes affirmative, a region defined by the scanning position and the size of the division range by which the minimal evaluation score was obtained, and which are stored in the system memory 14 or the hard disk 24 are designated as the division region, while the borders of the division range 48 are designated as the division locations (step S47), to complete the non-segmenting division process.

The non-segmenting division process enables division of processing target images, such as image 42 illustrated in FIG. 5A, such that the two people pictured therein are not segmented, as illustrated in FIG. 14A.

Note that if the processing target image is image 44 illustrated in FIG. 5B or image 46 illustrated in FIG. 5C, the divided images obtained by the apparatus 101 of the second embodiment would segment the main facial region thereof. For this reason, it is preferable for the number of segmentations to be considered when calculating the evaluation scores. Hereinafter, an apparatus having such a configuration will be described as a third embodiment of the present invention.

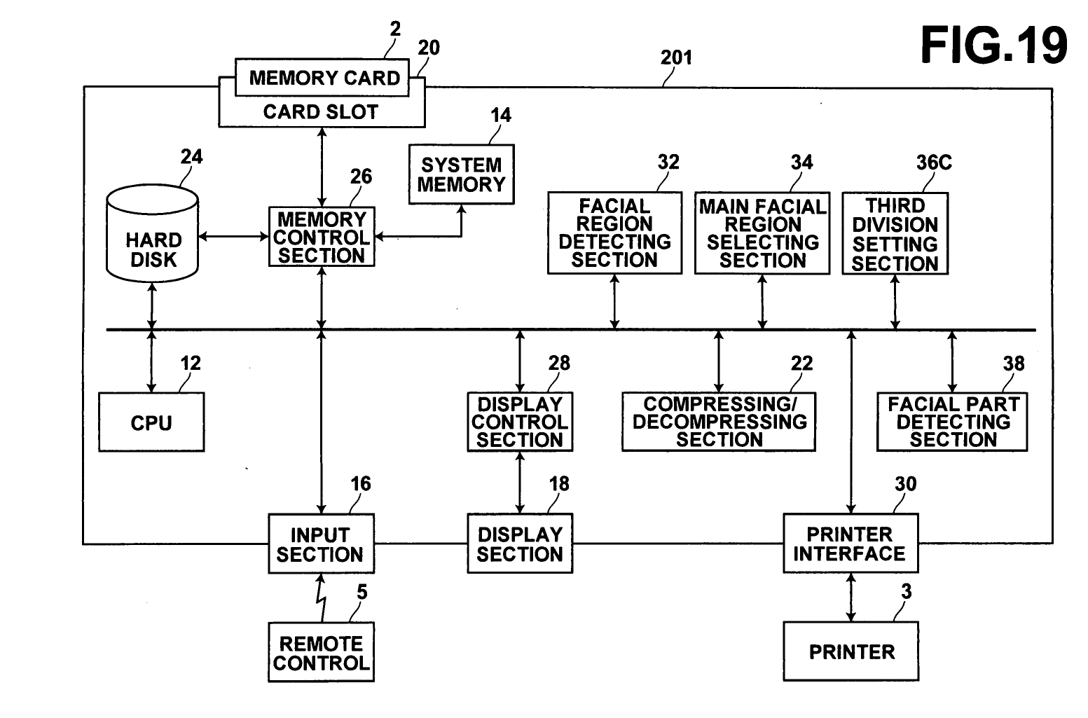

FIG. 19 is a schematic block diagram that illustrates the construction of an image dividing apparatus 201 (hereinafter, simply referred to as “apparatus 201”) according to the third embodiment of the present invention. Note that structural components of the apparatus 201 of the third embodiment which are the same as those of the apparatus 1 of the first embodiment will be denoted with the same reference numerals, and detailed descriptions thereof will be omitted. The apparatus 201 of the third embodiment is the same as the apparatus 101 of the second embodiment, except that the first division setting section 36A is replaced with a third division setting section 36C that calculates evaluation scores which are different from those calculated by the first division setting section 36A, and that the apparatus 201 comprises the facial part detecting section 38.

Hereinafter, the processes performed by the apparatus 201 of the third embodiment will be described. Note that only the content of the non-segmenting division process performed by the apparatus 201 of the third embodiment differs from the processes performed by the apparatus 101 of the second embodiment. Therefore, here, only the non-segmenting division process performed by the apparatus 201 of the third embodiment will be described.

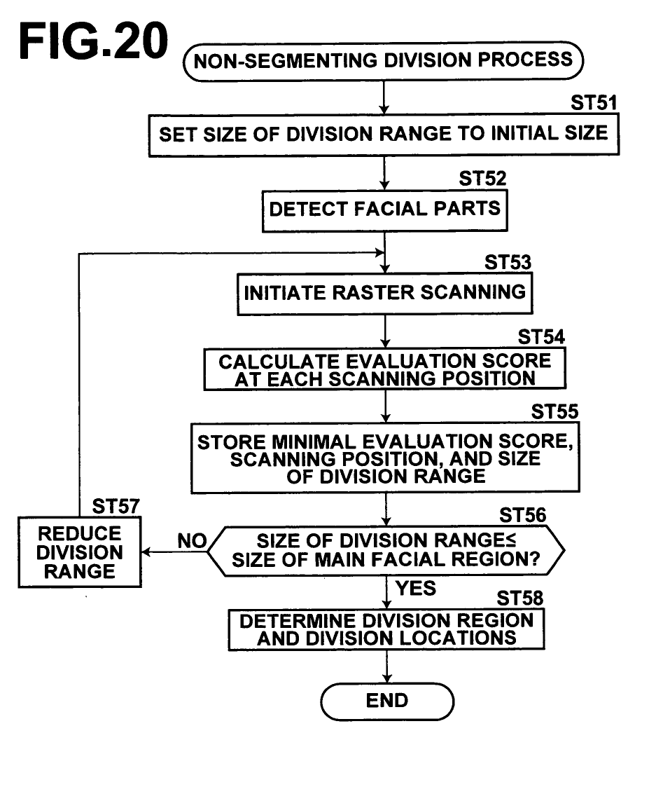

FIG. 20 is a flow chart that illustrates the non-segmenting division process performed by the apparatus 201 of the third embodiment. First, the CPU 12 sets the size of the division range to an initial size (step ST51). Next, the facial part detecting section 38 detects facial parts from within a main facial region pictured within a processing target image (step ST52).

Then, the third division setting section 36C performs a third division process. In the third division process, first, the third division setting section 36C initiates raster scanning of a predetermined search range within the processing target image, in a manner similar to that of the first embodiment (step ST53).

The third division setting section 36C calculates evaluation scores at each scanning position of the aforementioned raster scanning (step ST54). The third division setting section 36C calculates the area H21 of a blank region BL of the division range 48 that runs off the processing target image 46, a number of instances H22 that the boundaries within the division range 48 segment the main facial region, a number of instances H23 that the boundaries within the division range 48 segment the eyes, a number of instances H24 that the boundaries within the division range 48 segment the mouth, and a number of instances H25 that the boundaries within the division range 48 segment the nose at each scanning position of the division range 48. Note that the number of segmentations H22 of the main facial region is 4, number of segmentations H23 of the eyes is 2 for the right eye and 4 for the left eye for a total of 6, the number of segmentations H24 of the mouth is 2, and the number of segmentations H25 of the nose is 0 at the scanning position illustrated in FIG. 12. The evaluation score H20 is calculated at each of the scanning positions according to the following formula (3).
H20=H21+H22+α1×H23+α2×H24+α3×H25−H26 (3)
Note that H26 is the area of the division range 48. Note also that α1, α2, and α3 are weighting coefficients, having the relationship α1>α2>α3.

In the third embodiment, scanning positions at which the evaluation score H20 are lower have blank regions BL with smaller areas, fewer segmentations of the main facial region, fewer segmentations of the facial parts, and division ranges 48 with greater areas. Therefore, scanning positions at which the evaluation score H20 is low enable obtainment of more preferable divided images if the division range 48 at the scanning position is employed to divide the processing target image. In addition, because the relationship among the weighting coefficients is α1>α2>α3, even if the eyes, mouth, and nose are segmented the same number of times, the evaluation scores increase in the order of segmentation of the nose, segmentation of the mouth, and segmentation of the eyes. That is, cases in which the eyes are segmented result in higher evaluation scores than cases in which the nose and the mouth are segmented. The weighting coefficients are set in this manner, because people are characterized in the order of their eyes, their mouths, and their noses.

For this reason, the third division setting section 36C stores the minimal evaluation score, the scanning position at which the minimal evaluation score was calculated, and the size of the division range with which the scanning was performed in the system memory 14 or the hard disk 24, for each raster scanning of the search range (step ST55). When a single raster scan is completed, the third division setting section 36C judges whether the size of the division region 48 is less than or equal to the size of the main facial region (step ST56). If the result of judgment in step ST56 is negative, the division range 48 is reduced (step ST57), the process returns to step ST53, and the steps thereafter are repeated.

Note that from the second and following raster scans, the minimal evaluation score, the scanning position at which the minimal evaluation score was calculated, and the size of the division range with which the minimal evaluation score was calculated are stored in the system memory 14 or the hard disk 24 only in the case that a minimal evaluation score lower than that which is already stored in the system memory 14 or the hard disk 24 is calculated.

When the result of judgment at step ST56 becomes affirmative, a region defined by the scanning position and the size of the division range by which the minimal evaluation score was obtained, and which are stored in the system memory 14 or the hard disk 24 are designated as the division region, while the borders of the division range 48 are designated as the division locations (step S58), to complete the non-segmenting division process.

As illustrated in FIG. 15C, if the standard division process is administered on image 46 illustrated in FIG. 5C, the eyes, mouth, and the nose of the person pictured in the image are all segmented. However, if the non-segmenting division process of the third embodiment is administered, the division locations can be set such that only the nose and the mouth are segmented, as illustrated in FIG. 14C.

Note that in the third embodiment described above, it is judged whether the size of the division range is less than or equal to the size of the main facial region at step ST56. Alternatively, it may be judged whether the size of each of the division blocks of the division range is less than or equal to the size of the main facial region.

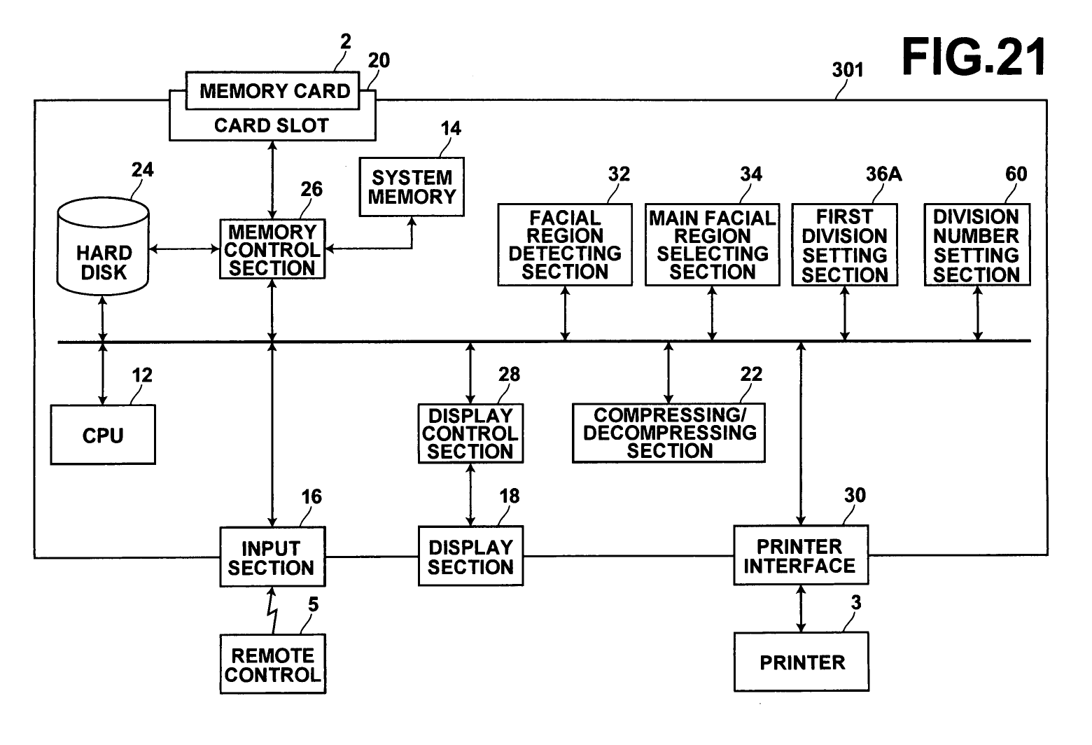

In the second and third embodiments described above, the division number is determined by user input. Alternatively, the division number may be set automatically. Hereinafter, an apparatus having such a configuration will be described as a fourth embodiment of the present invention. FIG. 21 is a schematic block diagram that illustrates the construction of an image dividing apparatus 301 (hereinafter, referred to as “apparatus 301”) according to the fourth embodiment of the present invention. Note that the fourth embodiment will be described as a case in which the division number is automatically set in the apparatus 101 of the second embodiment. Therefore, structural components of the apparatus 301 of the fourth embodiment which are the same as those of the apparatus 101 of the second embodiment will be denoted with the same reference numerals, and detailed descriptions thereof will be omitted. The apparatus 301 of the fourth embodiment is the same as the apparatus 101 of the second embodiment, except that the apparatus 301 further comprises a division number setting section 60, for setting the division number.

Note that the processes performed by the apparatus 301 of the fourth embodiment differ from the processes performed by the apparatus 101 of the second embodiment only in that the specification of the division number is replaced by a division number setting process. Therefore, here, only the division number setting process performed by the apparatus 301 of the fourth embodiment will be described.

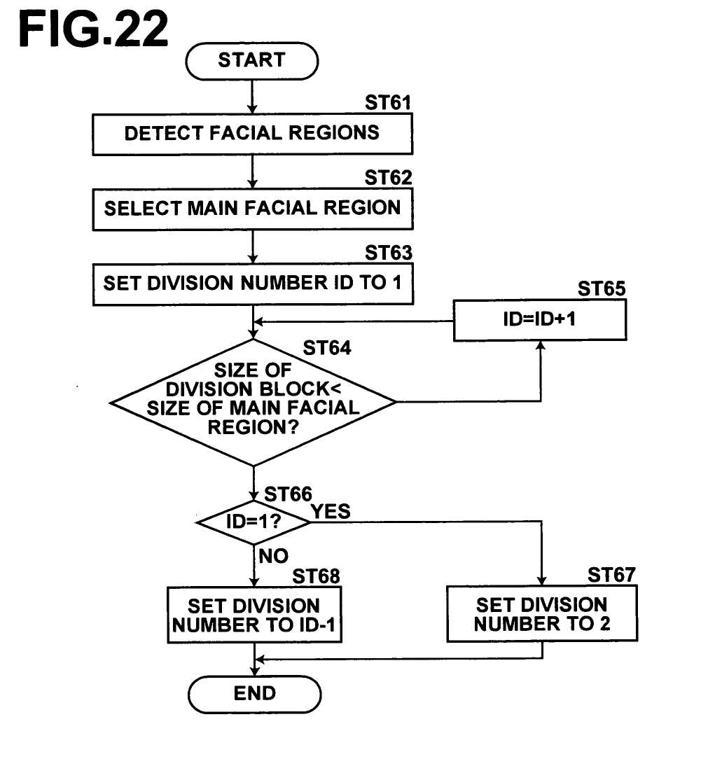

FIG. 22 is a flow chart that illustrates the steps of the division number setting process. First, the facial region detecting section 32 detects facial regions which are pictured within a processing target image (step ST61), and the main facial region selecting section 34 selects a main facial region from among the detected facial regions (step ST62). Note that the detected facial regions may be visibly displayed by the display section 18, and the user may select the main facial region by operating the remote control 5.

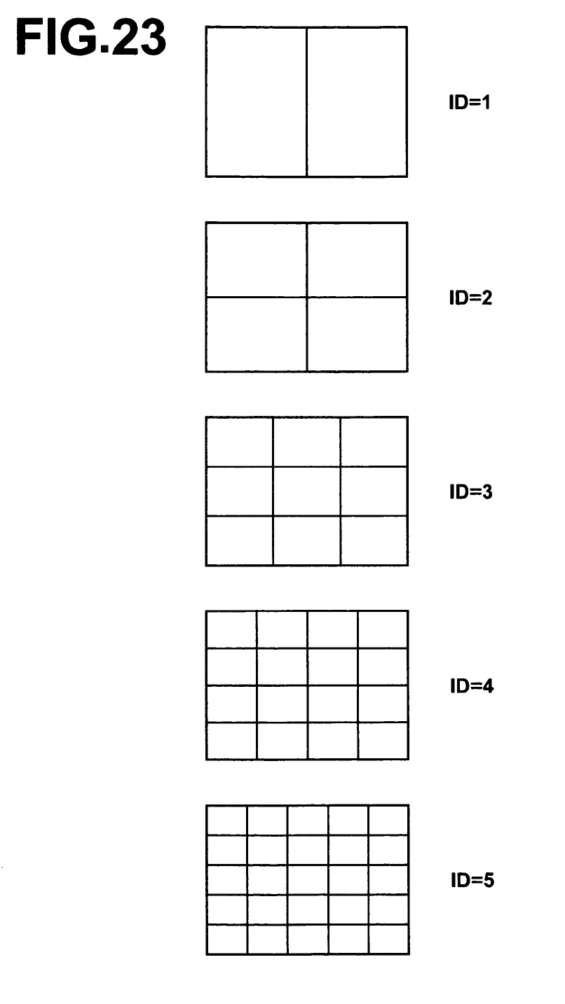

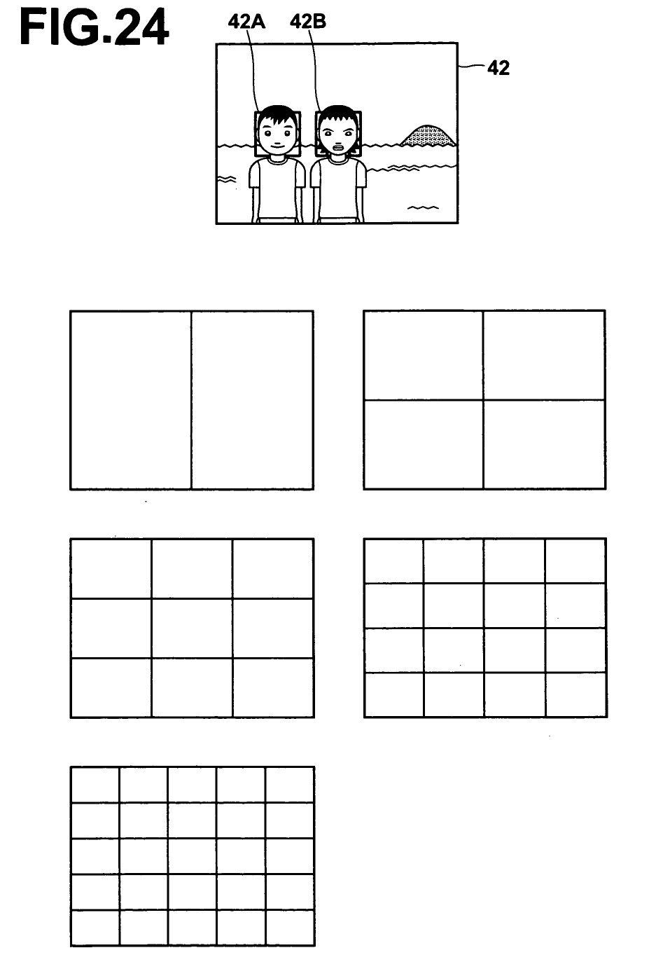

The division number setting section 60 sets a division number ID to 1 (step ST63). FIG. 23 is a diagram that illustrates division number ID's. As illustrated in FIG. 23, in the fourth embodiment, division number ID's are assigned to each of the division templates stored in the hard disk 24. Templates with two smaller regions, four smaller regions, 9 smaller regions, and 16 smaller regions are assigned division number ID's of 1, 2, 3, 4, and 5, respectively. Note that a division number ID of 0 indicates that no division is to be performed.

Thereafter, the division number setting section 60 judges whether the size of each of the division blocks of the template corresponding to the division number ID is smaller than the size of a main facial region, in the case that the entirety of a processing target image is designated to be the division range (step ST64). In the case that the result of judgment in step ST64 is affirmative, the division number ID is increased by 1 (step ST65), and the judgment of step ST64 is performed again.

In the case that the result of judgment in step S64 is negative, it is judged whether the present division number ID is 1 (step ST66). In the case that the result of judgment in step ST66 is affirmative, the division number is set to 2, which corresponds to division number ID 1 (step ST67), and the process ends. In the case that the result of judgment in step ST66 is negative, the division number is set to that corresponding to the division number ID immediately preceding the current division number ID (step ST68), and the process ends.

FIG. 24 is a diagram for explaining the setting of the division number. Note that FIG. 24 is for explaining the setting of the division number in the case that image 42 of FIG. 5A is the processing target image. As illustrated in FIG. 24, if the sizes of the division blocks are compared against the size of the main facial region 42B of image 42, the main facial region 42B can be inscribed within a division block when the division number is 16. However, if the division number is 25, the size of each division block becomes smaller than that of the main facial region 42B. For this reason, the division number is set to 16 for the processing target image 42. Note that the division number would be set to 9 for image 44 of FIG. 5B. In addition, the division number would be set to 2 or 4 for image 46 of FIG. 5C.

As described above, the apparatus 301 of the fourth embodiment sets the division number such that the size of the main facial region is smaller than that of the division blocks, and sets the division region and the division locations according to the set division number. Therefore, it becomes possible to position the division region and the division locations such that the main facial region is inscribed in a division region. Accordingly, segmentation of the main facial region can be positively prevented, particularly when the facial regions pictured in a processing target image are comparatively small.

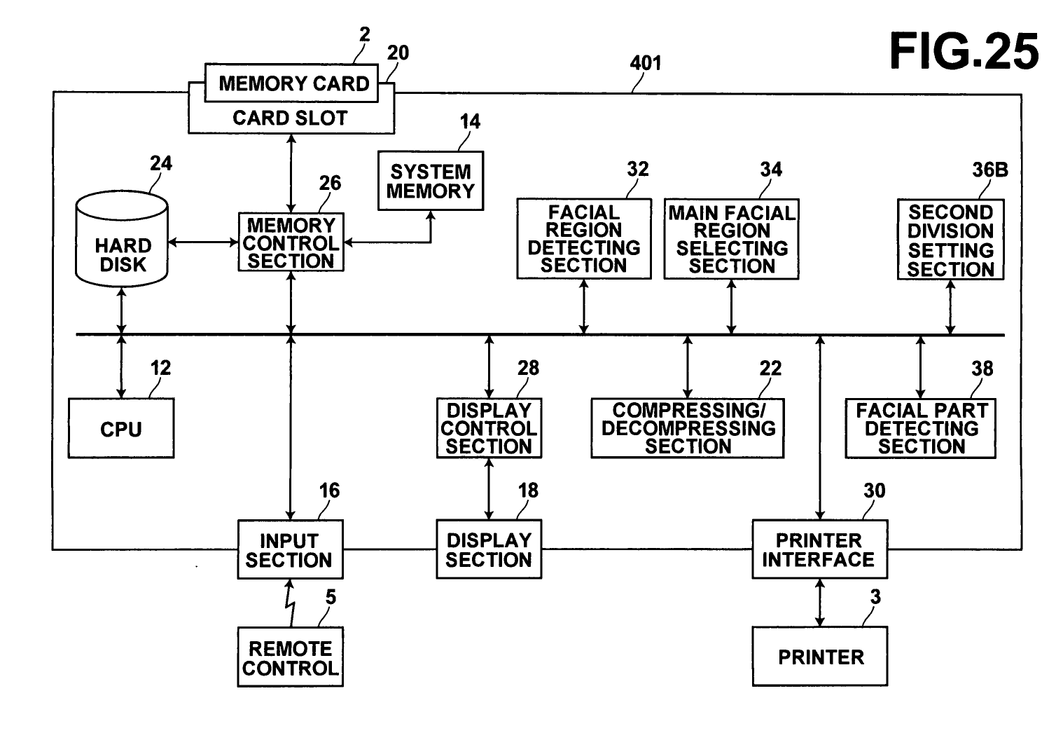

Next, a fifth embodiment of the present invention will be described. FIG. 25 is a schematic block diagram that illustrates the construction of an image dividing apparatus 401 (hereinafter, simply referred to as “apparatus 401”) according to the fifth embodiment of the present invention. Note that structural components of the apparatus 401 of the fifth embodiment which are the same as those of the apparatus 1 of the first embodiment will be denoted with the same reference numerals, and detailed descriptions thereof will be omitted. The apparatus 401 of the fifth embodiment is the same as the apparatus 1 of the first embodiment, except that the first division setting section 36A is omitted.

Hereinafter, the processes performed by the apparatus 401 of the fifth embodiment will be described. Note that only the content of the non-segmenting division process performed by the apparatus 401 of the fifth embodiment differs from the processes performed by the apparatus 1 of the first embodiment. Therefore, here, only the non-segmenting division process performed by the apparatus 401 of the fifth embodiment will be described.

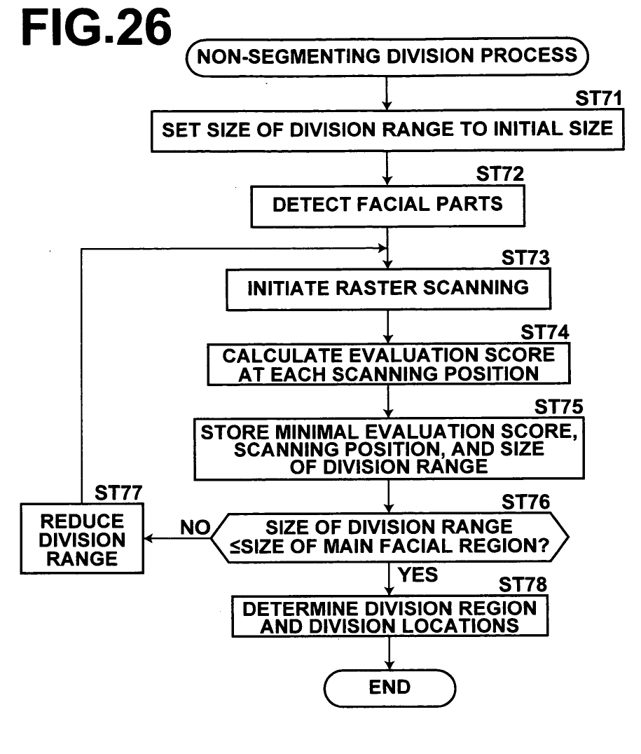

FIG. 26 is a flow chart that illustrates the non-segmenting division process performed by the apparatus 401 of the fifth embodiment. First, the CPU 12 sets the size of the division range to an initial size (step ST71). Next, the facial part detecting section 38 detects facial parts from within a main facial region pictured within a processing target image (step ST72). Then, the second division setting section 36B performs the second division process. In the second division process, first, the second division setting section 36B initiates raster scanning of a predetermined search range within the processing target image, in a manner similar to that of the first embodiment (step ST73).

The second division setting section 36B calculates evaluation scores at each scanning position of the aforementioned raster scanning according to Formula (2) (step S74). The second division setting section 36B stores the minimal evaluation score, the scanning position at which the minimal evaluation score was calculated, and the size of the division range with which the scanning was performed in the system memory 14 or the hard disk 24, for each raster scanning of the search range (step ST75). Note that in the fifth embodiment, the number of segmentations H12 of the eyes, the number of segmentations H13 of the mouths, and the number of segmentations H14 of the noses are the number of segmentations of eyes, mouths, and noses of all of the facial regions which are pictured within the processing target image. When a single raster scan is completed, the second division setting section 36B judges whether the size of the division range 48 is less than or equal to the size of the main facial region (step ST76). If the result of judgment in step ST76 is negative, the division range 48 is reduced (step ST77), the process returns to step ST73, and the steps thereafter are repeated.

Note that from the second and following raster scans, the minimal evaluation score, the scanning position at which the minimal evaluation score was calculated, and the size of the division range with which the minimal evaluation score was calculated are stored in the system memory 14 or the hard disk 24 only in the case that a minimal evaluation score lower than that which is already stored in the system memory 14 or the hard disk 24 is calculated.

When the result of judgment at step ST76 becomes affirmative, a region defined by the scanning position and the size of the division range by which the minimal evaluation score was obtained, and which are stored in the system memory 14 or the hard disk 24 are designated as the division region, while the borders of the division range 48 are designated as the division locations (step S78), to complete the non-segmenting division process.

The non-segmenting division process enables setting of division locations within processing target images such that the facial parts of the facial regions pictured therein are not segmented as much as possible.

Note that in the fifth embodiment described above, it is judged whether the size of the division range is less than or equal to the size of the main facial region at step ST76. Alternatively, it may be judged whether the size of each of the division blocks of the division range is less than or equal to the size of the main facial region.

Note that in each of the embodiments described above, the purpose of image division is divided printing. Alternatively, the purpose of image division may be to determine images to be displayed on each of a plurality of monitors, in the case that a single image is to be displayed on the plurality of monitors.

Image dividing apparatuses according to various embodiments of the present invention have been described above. Programs that cause a computer to function as the facial region detecting section 32, the main facial region selecting section 34, the first through third division setting sections 36A, 36B, and 36C, the facial part detecting section 38, and the division number setting section 60 and to execute the processes illustrated in FIGS. 2, 7, 18, 20, 22, and 26 are also embodiments of the present invention. In addition, computer readable media having such programs recorded therein are also embodiments of the present invention.

What is claimed is:

1. An image dividing apparatus for dividing an image that includes at least one face pictured therein into a plurality of smaller regions having a uniform size, comprising:
division number specifying means, for receiving specification of the number of smaller regions into which the image is to be divided;
facial region detecting means, for detecting at least one facial region within the image;
first division setting means, for setting a division region and division locations such that the boundaries of the smaller regions are at positions other than that of a main facial region;
facial part detecting means, for detecting facial parts included in the main facial region;
second division setting means, for setting a division region and division locations such that the boundaries of the smaller regions are at positions other than those of the facial parts included in the main facial region;
judging means, for judging whether the size of each of the specified number of smaller regions into which the image is to be divided is greater than the size of the main facial region; and
control means, for controlling the first division setting means, the facial part detecting means, and the second division setting means such that in the case that the result of judgment by the judging means is affirmative, the first division setting means sets the division region and the division locations, and in the case that the result of judgment by the judging means is negative, the facial part detecting means detects facial parts and the second division setting means sets the division region and the division locations.

2. An image dividing apparatus as defined in claim 1, wherein the first division setting means sets the division region and the division locations by:
setting a division range constituted by the plurality of smaller regions to an initial size, which is the same size as the size of the entire image, and decreasing the size in stepwise increments to a final size, at which the widths and heights of the smaller regions are less than or equal to those of the main facial region;
scanning the division range of each size on the image from a scanning initiation position to a scanning completion position;
calculating evaluation scores based on the area of blank regions of the division range that run off the image, the number of instances that the boundaries of the smaller regions segment the main facial region, and the area of the division range; and
setting the division range and the boundaries of the smaller regions at the scanning position where the evaluation score is minimal as the division region and the division locations.

3. An image dividing apparatus as defined in claim 1, wherein the second division setting means sets the division region and the division locations, by:
setting a division range constituted by the plurality of smaller regions to an initial size, which is the same size as the size of the entire image, and decreasing the size in stepwise increments to a final size, at which the widths and heights of the smaller regions are less than or equal to those of the main facial region;
scanning the division range of each size on the image from a scanning initiation position to a scanning completion position;
calculating evaluation scores based on the area of blank regions of the division range that run off the image, the number of instances that the boundaries of the smaller regions segment the facial parts, and the area of the division range; and
setting the division range and the boundaries of the smaller regions at the scanning position where the evaluation score is minimal as the division region and the division locations.

4. An image dividing apparatus as defined in claim 1, further comprising:
main facial region selecting means, for selecting a main facial region from among a plurality of facial regions, in the case that a plurality of facial regions are included in the image.

5. An image dividing apparatus as defined in claim 1, further comprising:
main facial region selection receiving means, for receiving input of selection of a main facial region from among a plurality of facial regions, in the case that a plurality of facial regions are included in the image.

6. An image dividing apparatus as defined in claim 1, further comprising:
display means, for displaying the boundaries that represent the set division region and the set division locations; and
correction command receiving means, for receiving commands to correct at least one of the division number, the division region, and the division locations.

7. An image dividing apparatus for dividing an image that includes at least one face pictured therein into a plurality of smaller regions having a uniform size, comprising:
facial region detecting means, for detecting at least one facial region within the image; and
division setting means, for setting a division region and division locations such that the boundaries of the smaller regions are at positions other than that of a main facial region.

8. An image dividing apparatus as defined in claim 7, further comprising:
facial part detecting means, for detecting facial parts included in the main facial region; and wherein
the division setting means sets the division region and the division locations such that the boundaries of the smaller regions are at positions other than those of the facial parts included in the main facial region.

9. An image dividing apparatus as defined in claim 7, wherein the division setting means sets the division region and the division locations by:
setting a division range constituted by the plurality of smaller regions to an initial size, which is the same size as the size of the entire image, and decreasing the size in stepwise increments to a final size, at which the widths and heights of the smaller regions are less than or equal to those of the main facial region;
scanning the division range of each size on the image from a scanning initiation position to a scanning completion position;
calculating evaluation scores based on the area of blank regions of the division range that run off the image, the number of instances that the boundaries of the smaller regions segment the main facial region, and the area of the division range; and
setting the division range and the boundaries of the smaller regions at the scanning position where the evaluation score is minimal as the division region and the division locations.

10. An image dividing apparatus as defined in claim 8, wherein the division setting means sets the division region and the division locations by:
setting a division range constituted by the plurality of smaller regions to an initial size, which is the same size as the size of the entire image, and decreasing the size in stepwise increments to a final size, at which the widths and heights of the smaller regions are less than or equal to those of the main facial region;
scanning the division range of each size on the image from a scanning initiation position to a scanning completion position;
calculating evaluation scores based on the area of blank regions of the division range that run off the image, the number of instances that the boundaries of the smaller regions segment the facial parts, and the area of the division range; and
setting the division range and the boundaries of the smaller regions at the scanning position where the evaluation score is minimal as the division region and the division locations.

11. An image dividing apparatus as defined in claim 7, further comprising:
division number setting means, for setting the number of smaller regions into which the image is to be divided such that the sizes of the smaller regions are greater than the size of the main facial region; wherein
the division setting means sets the division region and the division locations according to the set division number.

12. An image dividing apparatus as defined in claim 7, further comprising:
division number specifying means, for receiving specification of the number of smaller regions into which the image is to be divided; wherein
the division setting means sets the division region and the division locations according to the specified division number.

13. An image dividing apparatus as defined in claim 7, further comprising:
main facial region selecting means, for selecting a main facial region from among a plurality of facial regions, in the case that a plurality of facial regions are included in the image.

14. An image dividing apparatus as defined in claim 8, further comprising:
main facial region selection receiving means, for receiving input of selection of a main facial region from among a plurality of facial regions, in the case that a plurality of facial regions are included in the image.

15. An image dividing apparatus as defined in claim 7, further comprising:
display means, for displaying the boundaries that represent the set division region and the set division locations; and
correction command receiving means, for receiving commands to correct at least one of the division number, the division region, and the division locations.

16. An image dividing apparatus for dividing an image that includes at least one face pictured therein into a plurality of smaller regions having a uniform size, comprising:
facial region detecting means, for detecting at least one facial region within the image;
facial part detecting means, for detecting facial parts included in the at least one facial region; and
division setting means, for setting a division region and division locations such that the boundaries of the smaller regions are at positions other than those of the facial parts included in the at least one facial region.

17. An image dividing apparatus as defined in claim 16, wherein the division setting means sets the division region and the division locations by:
setting a division range constituted by the plurality of smaller regions to an initial size, which is the same size as the size of the entire image, and decreasing the size in stepwise increments to a final size, at which the widths and heights of the smaller regions are less than or equal to those of the main facial region;
scanning the division range of each size on the image from a scanning initiation position to a scanning completion position;
calculating evaluation scores based on the area of blank regions of the division range that run off the image, the number of instances that the boundaries of the smaller regions segment the facial parts, and the area of the division range; and
setting the division range and the boundaries of the smaller regions at the scanning position where the evaluation score is minimal as the division region and the division locations.

18. An image dividing apparatus as defined in claim 16, further comprising:
division number specifying means, for receiving specification of the number of smaller regions into which the image is to be divided; wherein
the division setting means sets the division region and the division locations according to the specified division number.

19. An image dividing apparatus as defined in claim 16, further comprising:
display means, for displaying the boundaries that represent the set division region and the set division locations; and
correction command receiving means, for receiving commands to correct at least one of the division number, the division region, and the division locations.

20. An image dividing method for dividing an image that includes at least one face pictured therein into a plurality of smaller regions having a uniform size, comprising the steps of:
receiving specification of the number of smaller regions into which the image is to be divided;
detecting at least one facial region within the image;
judging whether the size of each of the specified number of smaller regions into which the image is to be divided is greater than the size of the main facial region; and
setting a division region and division locations such that the boundaries of the smaller regions are at positions other than that of a main facial region in the case that the result of judgment is affirmative, while detecting facial parts included in the main facial region and setting a division region and division locations such that the boundaries of the smaller regions are at positions other than those of the facial parts included in the main facial region in the case that the result of judgment is negative.

21. An image dividing method for dividing an image that includes at least one face pictured therein into a plurality of smaller regions having a uniform size, comprising the steps of:
detecting at least one facial region within the image; and
setting a division region and division locations such that the boundaries of the smaller regions are at positions other than that of a main facial region.

22. An image dividing method for dividing an image that includes at least one face pictured therein into a plurality of smaller regions having a uniform size, comprising the steps of:
detecting at least one facial region within the image;
detecting facial parts included in the at least one facial region; and
setting a division region and division locations such that the boundaries of the smaller regions are at positions other than those of the facial parts included in the at least one facial region.

23. A program that causes a computer to execute an image dividing method for dividing an image that includes at least one face pictured therein into a plurality of smaller regions having a uniform size, comprising the procedures of:
receiving specification of the number of smaller regions into which the image is to be divided;
detecting at least one facial region within the image;
judging whether the size of each of the specified number of smaller regions into which the image is to be divided is greater than the size of the main facial region; and
setting a division region and division locations such that the boundaries of the smaller regions are at positions other than that of a main facial region in the case that the result of judgment is affirmative, while detecting facial parts included in the main facial region and setting a division region and division locations such that the boundaries of the smaller regions are at positions other than those of the facial parts included in the main facial region in the case that the result of judgment is negative.

24. A program that causes a computer to execute an image dividing method for dividing an image that includes at least one face pictured therein into a plurality of smaller regions having a uniform size, comprising the procedures of:
detecting at least one facial region within the image; and
setting a division region and division locations such that the boundaries of the smaller regions are at positions other than that of a main facial region.

25. A program that causes a computer to execute an image dividing method for dividing an image that includes at least one face pictured therein into a plurality of smaller regions having a uniform size, comprising the procedures of:
detecting at least one facial region within the image;
detecting facial parts included in the at least one facial region; and
setting a division region and division locations such that the boundaries of the smaller regions are at positions other than those of the facial parts included in the at least one facial region.
